(19) United States
(12) Patent Application Publication
(10) Pub. No.: US 2026/0371206 A1
(43) Pub. Date: Nov. 19, 2026

(54) CROSS-SERVING CELL PREDICTIVE BEAM MANAGEMENT

(71) Applicant: QUALCOMM Incorporated, San Diego, CA (US)

(72) Inventors: Qiaoyu LI, Beijing (CN); Mahmoud TAHERZADEH BOROUJENI, San Diego, CA (US); Tao LUO, San Diego, CA (US)

(21) Appl. No.: 19/143,308

(22) PCT Filed: Feb. 13, 2023
(86) PCT No.: PCT/CN2023/075604

§ 371 Date: Jun. 26, 2025

(51) Int. Cl. H04W 36/30; H04B 17/373; H04W 36/00; H04W 36/08; H04W 76/27

(52) U.S. Cl. CPC H04W 36/304; H04B 17/373; H04W 36/0058; H04W 36/0072; H04W 36/085; H04W 76/27

(57) ABSTRACT

Methods, systems, and devices for wireless communications are described. A user equipment (UE) may receive, from a first serving cell, control signaling indicating a cross serving cell scheme that identifies a first set of resources of a second serving cell, for measuring channel quality for a first set of beams, that are associated with a second set of resources of the second serving cell, for predicting channel quality for a second set of beams. The UE may perform channel measurements via the first set of resources using the first set of beams according to the cross serving cell scheme. The UE may transmit, to the first serving cell based on the one or more channel measurements and the cross serving cell scheme, a channel state information report indicating predicted channel quality information for the second set of resources for the second set of beams associated with the second serving cell.

### CROSS REFERENCE

The present Application is a 371 national phase filing of International PCT Application No. PCT/CN2023/075604 by LI et al., entitled “CROSS-SERVING CELL PREDICTIVE BEAM MANAGEMENT,” filed Feb. 13, 2023, which is assigned to the assignee hereof, and which is expressly incorporated by reference in its entirety herein.

### FIELD OF TECHNOLOGY

The following relates to wireless communications, including cross-serving cell predictive beam management.

### BACKGROUND

Wireless communications systems are widely deployed to provide various types of communication content such as voice, video, packet data, messaging, broadcast, and so on. These systems may be capable of supporting communication with multiple users by sharing the available system resources (e.g., time, frequency, and power). Examples of such multiple-access systems include fourth generation (4G) systems such as Long Term Evolution (LTE) systems, LTE-Advanced (LTE-A) systems, or LTE-A Pro systems, and fifth generation (5G) systems which may be referred to as New Radio (NR) systems. These systems may employ technologies such as code division multiple access (CDMA), time division multiple access (TDMA), frequency division multiple access (FDMA), orthogonal FDMA (OFDMA), or discrete Fourier transform spread orthogonal frequency division multiplexing (DFT-S-OFDM). A wireless multiple-access communications system may include one or more base stations, each supporting wireless communication for communication devices, which may be known as user equipment (UE). In some wireless communications systems, a UE may perform predictive channel quality measurements in a first serving cell. The UE may also be mobile and may move between various serving cells.

### SUMMARY

The described techniques relate to improved methods, systems, devices, and apparatuses that support cross-serving cell predictive beam management. For example, the described techniques provide for a cross serving cell scheme that enables a user equipment (UE) (e.g., located in a first serving cell) to perform predictive channel quality measurements for a second serving cell and report the measurements in a channel state information (CSI) report of the first serving cell. The UE may receive a CSI report information message from a network entity that identifies a first set of actual resources, corresponding to a first set of beams, and a second set of resources (e.g., virtual resources), corresponding to a second set of beams. The UE may perform channel quality measurements via the first set of resources using the first set of beams and may perform channel quality measurement predictions for the second set of resources for the second set of beams. The network entity may indicate an association between the first set of resources and the second set of resources in the CSI report information message, for example, by using codepoints in a radio resource control (RRC) configured codebook at the second serving cell. In some examples, the UE may transmit, to the network entity in the first serving cell, a CSI report that includes the predicted measurements (e.g., for the second set of beams) of the second serving cell.

A method for wireless communications at a user equipment (UE) is described. The method may include receiving, from a first serving cell, control signaling indicating a cross serving cell scheme that identifies a first set of resources of a second serving cell that are associated with a second set of resources of the second serving cell, the first set of resources for measuring channel quality for a first set of beams and the second set of resources for predicting channel quality for a second set of beams, performing one or more channel measurements via the first set of resources using the first set of beams according to the cross serving cell scheme, and transmitting, to the first serving cell based on the one or more channel measurements and the cross serving cell scheme, a CSI report indicating predicted channel quality information for the second set of resources for the second set of beams associated with the second serving cell.

An apparatus for wireless communications at a UE is described. The apparatus may include at least one processor, and memory coupled (e.g., operatively, communicatively, functionally, electronically, or electrically) with the at least one processor, the memory storing instructions of the at least one processor to cause the UE to receive, from a first serving cell, control signaling indicating a cross serving cell scheme that identifies a first set of resources of a second serving cell that are associated with a second set of resources of the second serving cell, the first set of resources for measuring channel quality for a first set of beams and the second set of resources for predicting channel quality for a second set of beams, perform one or more channel measurements via the first set of resources using the first set of beams according to the cross serving cell scheme, and transmit, to the first serving cell based on the one or more channel measurements and the cross serving cell scheme, a CSI report indicating predicted channel quality information for the second set of resources for the second set of beams associated with the second serving cell.

Another apparatus for wireless communications at a UE is described. The apparatus may include means for receiving, from a first serving cell, control signaling indicating a cross serving cell scheme that identifies a first set of resources of a second serving cell that are associated with a second set of resources of the second serving cell, the first set of resources for measuring channel quality for a first set of beams and the second set of resources for predicting channel quality for a second set of beams, means for performing one or more channel measurements via the first set of resources using the first set of beams according to the cross serving cell scheme, and means for transmitting, to the first serving cell based on the one or more channel measurements and the cross serving cell scheme, a CSI report indicating predicted channel quality information for the second set of resources for the second set of beams associated with the second serving cell.

A non-transitory computer-readable medium storing code for wireless communications at a UE is described. The code may include instructions executable by at least one processor (e.g., directly, indirectly, after pre-processing, without pre-processing) to receive, from a first serving cell, control signaling indicating a cross serving cell scheme that identifies a first set of resources of a second serving cell that are associated with a second set of resources of the second serving cell, the first set of resources for measuring channel quality for a first set of beams and the second set of resources for predicting channel quality for a second set of beams, perform one or more channel measurements via the first set of resources using the first set of beams according to the cross serving cell scheme, and transmit, to the first serving cell based on the one or more channel measurements and the cross serving cell scheme, a CSI report indicating predicted channel quality information for the second set of resources for the second set of beams associated with the second serving cell.

In some examples of the method, apparatuses, and non-transitory computer-readable medium described herein, receiving the control signaling may include operations, features, means, or instructions for receiving CSI reporting information including an indication of an identifier of the second serving cell, where the CSI reporting information includes an indication of the first set of resources and the second set of resources defined with reference to the identifier of the second serving cell.

In some examples of the method, apparatuses, and non-transitory computer-readable medium described herein, receiving the CSI reporting information may include operations, features, means, or instructions for receiving a CSI report setting message, a medium access control (MAC) control element (CE) activating the CSI report, a CSI configuration message triggering the CSI report, or any combination thereof.

In some examples of the method, apparatuses, and non-transitory computer-readable medium described herein, receiving the control signaling may include operations, features, means, or instructions for receiving CSI reporting information including an indication of an identifier of the first serving cell and a set of multiple resources including the first set of resources and the second set of resources, where each resource of the first set of resources and the second set of resources corresponds to an identifier of the second serving cell.

Some examples of the method, apparatuses, and non-transitory computer-readable medium described herein may further include operations, features, means, or instructions for receiving, from the second serving cell, a control message including configuration information indicating each resource of the first set of resources and the second set of resources, a beam direction for each of the first set of beams and the second set of beams, or a combination thereof, where the cross serving cell scheme identifies the first set of resources, the first set of beams, the second set of resources, the second set of beams, or any combination thereof, based on the configuration information.

Some examples of the method, apparatuses, and non-transitory computer-readable medium described herein may further include operations, features, means, or instructions for receiving, via the configuration information, an indication of a codebook including a set of candidate resources, a set of candidate beam directions, a set of candidate beam widths, or any combination thereof, where the cross serving cell scheme includes a codepoint of the codebook indicating the first set of resources, the first set of beams, the second set of resources, the second set of beams, or any combination thereof.

Some examples of the method, apparatuses, and non-transitory computer-readable medium described herein may further include operations, features, means, or instructions for transmitting capability information indicating that the UE supports beam prediction based on the cross serving cell scheme, where receiving the control signaling indicating the cross serving cell scheme may be based on the capability information.

Some examples of the method, apparatuses, and non-transitory computer-readable medium described herein may further include operations, features, means, or instructions for transmitting, via the capability information, an indication that the UE supports beam prediction for the second serving cell via the first serving cell.

Some examples of the method, apparatuses, and non-transitory computer-readable medium described herein may further include operations, features, means, or instructions for transmitting, via the capability information, a quantity of serving cells for which the UE supports the cross serving cell scheme, the quantity of serving cells including the second serving cell.

Some examples of the method, apparatuses, and non-transitory computer-readable medium described herein may further include operations, features, means, or instructions for transmitting, via the capability information, an indication of a threshold prediction accuracy for the second serving cell.

In some examples of the method, apparatuses, and non-transitory computer-readable medium described herein, the threshold prediction accuracy may be based on a location of the UE.

Some examples of the method, apparatuses, and non-transitory computer-readable medium described herein may further include operations, features, means, or instructions for transmitting, via the capability information, an indication of a quantity of beams in the second set of beams, a type of beams for the second set of beams, or a combination thereof, based on the threshold prediction accuracy.

A method for wireless communications at a network entity is described. The method may include transmitting, via a first serving cell to a UE, control signaling indicating a cross serving cell scheme that identifies a first set of resources of a second serving cell that are associated with a second set of resources of the second serving cell, the first set of resources for measuring channel quality for a first set of beams and the second set of resources for predicting channel quality for a second set of beams and receiving, from the UE via the first serving cell, based on the cross serving cell scheme, a CSI report indicating predicted channel quality information for the second set of resources for the second set of beams associated with the second serving cell.

An apparatus for wireless communications at a network entity is described. The apparatus may include at least one processor, and memory coupled (e.g., operatively, communicatively, functionally, electronically, or electrically) with the at least one processor, the memory storing instructions executable by the at least one processor to cause the network entity to transmit, via a first serving cell to a UE, control signaling indicating a cross serving cell scheme that identifies a first set of resources of a second serving cell that are associated with a second set of resources of the second serving cell, the first set of resources for measuring channel quality for a first set of beams and the second set of resources for predicting channel quality for a second set of beams and receive, from the UE via the first serving cell, based on the cross serving cell scheme, a CSI report indicating predicted channel quality information for the second set of resources for the second set of beams associated with the second serving cell.

Another apparatus for wireless communications at a network entity is described. The apparatus may include means for transmitting, via a first serving cell to a UE, control signaling indicating a cross serving cell scheme that identifies a first set of resources of a second serving cell that are associated with a second set of resources of the second serving cell, the first set of resources for measuring channel quality for a first set of beams and the second set of resources for predicting channel quality for a second set of beams and means for receiving, from the UE via the first serving cell, based on the cross serving cell scheme, a CSI report indicating predicted channel quality information for the second set of resources for the second set of beams associated with the second serving cell.

A non-transitory computer-readable medium storing code for wireless communications at a network entity is described. The code may include instructions executable by at least one processor (e.g., directly, indirectly, after pre-processing, without pre-processing) to transmit, via a first serving cell to a UE, control signaling indicating a cross serving cell scheme that identifies a first set of resources of a second serving cell that are associated with a second set of resources of the second serving cell, the first set of resources for measuring channel quality for a first set of beams and the second set of resources for predicting channel quality for a second set of beams and receive, from the UE via the first serving cell, based on the cross serving cell scheme, a CSI report indicating predicted channel quality information for the second set of resources for the second set of beams associated with the second serving cell.

In some examples of the method, apparatuses, and non-transitory computer-readable medium described herein, transmitting the control signaling may include operations, features, means, or instructions for transmitting CSI reporting information including an indication of an identifier of the second serving cell, where the CSI reporting information includes an indication of the first set of resources and the second set of resources defined with reference to the identifier of the second serving cell.

In some examples of the method, apparatuses, and non-transitory computer-readable medium described herein, transmitting the control signaling may include operations, features, means, or instructions for transmitting a CSI report setting message, a MAC-CE activating the CSI report, a CSI configuration message triggering the CSI report, or any combination thereof.

In some examples of the method, apparatuses, and non-transitory computer-readable medium described herein, transmitting the control signaling may include operations, features, means, or instructions for CSI reporting information including an indication of an identifier of the first serving cell and a set of multiple resources including the first set of resources and the second set of resources, where each resource of the first set of resources and the second set of resources corresponds to an identifier of the second serving cell.

In some examples of the method, apparatuses, and non-transitory computer-readable medium described herein, the cross serving cell scheme identifies the first set of resources, the first set of beams, the second set of resources, the second set of beams, or any combination thereof, based on configuration information from the second serving cell indicating each resource of the first set of resources and the second set of resources, a beam direction for each of the first set of beams and the second set of beams, or a combination thereof.

In some examples of the method, apparatuses, and non-transitory computer-readable medium described herein, an indication of a codebook including a set of candidate resources, a set of candidate beam directions, a set of candidate beam widths, or any combination thereof and the cross serving cell scheme includes a codepoint of the codebook indicating the first set of resources, the first set of beams, the second set of resources, the second set of beams, or any combination thereof.

Some examples of the method, apparatuses, and non-transitory computer-readable medium described herein may further include operations, features, means, or instructions for receiving capability information indicating that the UE supports beam prediction based on the cross serving cell scheme, where transmitting the control signaling indicating the cross serving cell scheme may be based on the capability information.

Some examples of the method, apparatuses, and non-transitory computer-readable medium described herein may further include operations, features, means, or instructions for receiving, via the capability information, a quantity of serving cells for which the UE supports the cross serving cell scheme, the quantity of serving cells including the second serving cell.

Some examples of the method, apparatuses, and non-transitory computer-readable medium described herein may further include operations, features, means, or instructions for receiving, via the capability information, an indication of a threshold prediction accuracy for the second serving cell.

In some examples of the method, apparatuses, and non-transitory computer-readable medium described herein, the threshold prediction accuracy may be based on a location of the UE.

Some examples of the method, apparatuses, and non-transitory computer-readable medium described herein may further include operations, features, means, or instructions for receiving, via the capability information, an indication of a quantity of beams in the second set of beams, a type of beams for the second set of beams, or a combination thereof, based on the threshold prediction accuracy.

### BRIEF DESCRIPTION OF THE DRAWINGS

FIG. 1 illustrates an example of a wireless communications system that supports cross-serving cell predictive beam management in accordance with one or more aspects of the present disclosure.

FIG. 2 illustrates an example of a wireless communications system that supports cross-serving cell predictive beam management in accordance with one or more aspects of the present disclosure.

FIG. 3 illustrates an example of a channel measurement scheme that supports cross-serving cell predictive beam management in accordance with one or more aspects of the present disclosure.

FIGS. 4A and 4B illustrate examples of CSI reporting configurations that support cross-serving cell predictive beam management in accordance with one or more aspects of the present disclosure.

FIG. 5 illustrates an example of a process flow that supports cross-serving cell predictive beam management in accordance with one or more aspects of the present disclosure.

FIGS. 6 and 7 illustrate block diagrams of devices that support cross-serving cell predictive beam management in accordance with one or more aspects of the present disclosure.

FIG. 8 illustrates a block diagram of a communications manager that supports cross-serving cell predictive beam management in accordance with one or more aspects of the present disclosure.

FIG. 9 illustrates a diagram of a system including a device that supports cross-serving cell predictive beam management in accordance with one or more aspects of the present disclosure.

FIGS. 10 and 11 illustrate block diagrams of devices that support cross-serving cell predictive beam management in accordance with one or more aspects of the present disclosure.

FIG. 12 illustrates a block diagram of a communications manager that supports cross-serving cell predictive beam management in accordance with one or more aspects of the present disclosure.

FIG. 13 illustrates a diagram of a system including a device that supports cross-serving cell predictive beam management in accordance with one or more aspects of the present disclosure.

FIGS. 14 through 19 illustrate flowcharts showing methods that support cross-serving cell predictive beam management in accordance with one or more aspects of the present disclosure.

### DETAILED DESCRIPTION

In some wireless communications systems, a user equipment (UE) may report, to a network entity, measurements associated with one or more resources (e.g., channel measurement resources (CMRs)) for communications between the UE and the network entity in a channel state information (CSI) report. The CSI report may indicate channel quality information or beam information based on which the network entity may schedule or configure subsequent communications. The UE may perform CSI measurements via a first set of resources using a first set of beams (set A beams) and may generate a CSI report that includes predicted CSI measurements for a second set of resources using a second set of beams (set B beams) that is linked to the first set of resources within a given cell (e.g., a first serving cell). In some examples, the first set of resources may be actual resources and the second set of resources may be virtual resources. The UE may be mobile and may change its geo-location over time (e.g., may switch from a first cell to a second cell). CSI measurements and predictions in one cell may not be applicable for a second serving cell, or in cases where one or more beams may be used in multiple cells, re-performing beam measurements and CSI reporting in each cell (e.g., as part of or subsequent to mobility procedures) may be inefficient.

In some cases, the UE may support enhanced signaling to include, in a CSI report for the first cell, predicted CSI measurements for the second cell. The resources (e.g., the first and second sets of resources for generating the predicted CSI measurements) may be defined with reference to the second cell, but the CSI reporting may be configured by the first cell, the second cell, or both, and may be triggered by and reported to the first serving cell. In some examples, resources for CSI measurements in the first cell and resources for CSI measurements in the second cell may be configured as sets of resources identified by the identifier of the second serving cell (e.g., in CSI reporting configuration provided by the first cell, a set of resources for predicant CSI measurements in the second cell may be indicated and associated with a cell identifier of the second serving cell). In some examples, the first serving cell may provide CSI reporting information for the first serving cell, which may include the one or more sets of resources, where each resource for CSI measurements in the second serving cell is individually identified with the identifier of the second serving cell. In some cases, the UE may report capability information indicating that the UE is capable of supporting cross serving cell predictive CSI reporting, and may be configured for cross serving cell predictive CSI reporting based thereon.

By including predicted CSI measurements for the second cell in a CSI report for the first cell, the UE may reduce latency associated with UE mobility or switching service cells. For example, the UE may reduce a time delay associated with performing new channel measurements based on switching from the first cell to the second cell. The UE may instead perform the channel quality measurements corresponding to communications in the second serving cell in advance, and thus reduce communication delays associated with communications with a network entity in the second cell. In some cases, the UE may perform channel measurements in the first serving cell that are relevant to communications in the second serving cell, and the UE may apply the resources for communications in the second serving cell without performing new measurements, which may reduce redundancy in measurements or processes and support more efficient utilization of resources.

Aspects of the disclosure are initially described in the context of wireless communications systems. Aspects of the disclosure are further described in the context of channel measurement schemes, CSI reporting configurations, and process flows. Aspects of the disclosure are further illustrated by and described with reference to apparatus diagrams, system diagrams, and flowcharts that relate to cross-serving cell predictive beam management.

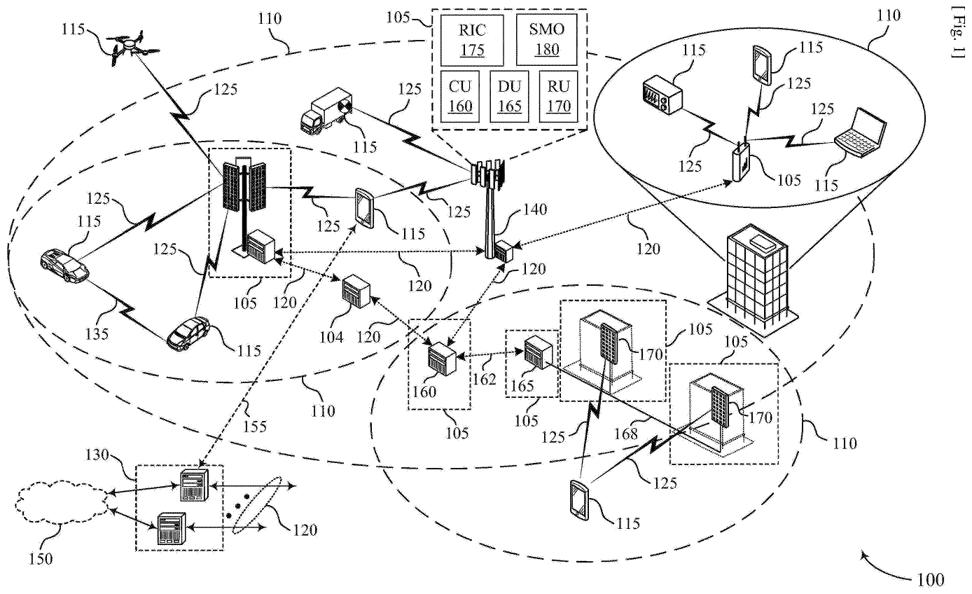

FIG. 1 illustrates an example of a wireless communications system 100 that supports cross-serving cell predictive beam management in accordance with one or more aspects of the present disclosure. The wireless communications system 100 may include one or more network entities 105, one or more UEs 115, and a core network 130. In some examples, the wireless communications system 100 may be a Long Term Evolution (LTE) network, an LTE-Advanced (LTE-A) network, an LTE-A Pro network, a New Radio (NR) network, or a network operating in accordance with other systems and radio technologies, including future systems and radio technologies not explicitly mentioned herein.

The network entities 105 may be dispersed throughout a geographic area to form the wireless communications system 100 and may include devices in different forms or having different capabilities. In various examples, a network entity 105 may be referred to as a network element, a mobility element, a radio access network (RAN) node, or network equipment, among other nomenclature. In some examples, network entities 105 and UEs 115 may wirelessly communicate via one or more communication links 125 (e.g., a radio frequency (RF) access link). For example, a network entity 105 may support a coverage area 110 (e.g., a geographic coverage area) over which the UEs 115 and the network entity 105 may establish one or more communication links 125. The coverage area 110 may be an example of a geographic area over which a network entity 105 and a UE 115 may support the communication of signals according to one or more radio access technologies (RATs).

The UEs 115 may be dispersed throughout a coverage area 110 of the wireless communications system 100, and each UE 115 may be stationary, or mobile, or both at different times. The UEs 115 may be devices in different forms or having different capabilities. Some example UEs 115 are illustrated in FIG. 1. The UEs 115 described herein may be capable of supporting communications with various types of devices, such as other UEs 115 or network entities 105, as shown in FIG. 1.

As described herein, a node of the wireless communications system 100, which may be referred to as a network node, or a wireless node, may be a network entity 105 (e.g., any network entity described herein), a UE 115 (e.g., any UE described herein), a network controller, an apparatus, a device, a computing system, one or more components, or another suitable processing entity configured to perform any of the techniques described herein. For example, a node may be a UE 115. As another example, a node may be a network entity 105. As another example, a first node may be configured to communicate with a second node or a third node. In one aspect of this example, the first node may be a UE 115, the second node may be a network entity 105, and the third node may be a UE 115. In another aspect of this example, the first node may be a UE 115, the second node may be a network entity 105, and the third node may be a network entity 105. In yet other aspects of this example, the first, second, and third nodes may be different relative to these examples. Similarly, reference to a UE 115, network entity 105, apparatus, device, or computing system may include disclosure of the UE 115, network entity 105, apparatus, device, or computing system being a node. For example, disclosure that a UE 115 is configured to receive information from a network entity 105 also discloses that a first node is configured to receive information from a second node.

In some examples, network entities 105 may communicate with the core network 130, or with one another, or both. For example, network entities 105 may communicate with the core network 130 via one or more backhaul communication links 120 (e.g., in accordance with an S1, N2, N3, or other interface protocol). In some examples, network entities 105 may communicate with one another via a backhaul communication link 120 (e.g., in accordance with an X2, Xn, or other interface protocol) either directly (e.g., directly between network entities 105) or indirectly (e.g., via a core network 130). In some examples, network entities 105 may communicate with one another via a midhaul communication link 162 (e.g., in accordance with a midhaul interface protocol) or a fronthaul communication link 168 (e.g., in accordance with a fronthaul interface protocol), or any combination thereof. The backhaul communication links 120, midhaul communication links 162, or fronthaul communication links 168 may be or include one or more wired links (e.g., an electrical link, an optical fiber link), one or more wireless links (e.g., a radio link, a wireless optical link), among other examples or various combinations thereof. A UE 115 may communicate with the core network 130 via a communication link 155.

One or more of the network entities 105 described herein may include or may be referred to as a base station 140 (e.g., a base transceiver station, a radio base station, an NR base station, an access point, a radio transceiver, a NodeB, an eNodeB (eNB), a next-generation NodeB or a giga-NodeB (either of which may be referred to as a gNB), a 5G NB, a next-generation eNB (ng-eNB), a Home NodeB, a Home eNodeB, or other suitable terminology). In some examples, a network entity 105 (e.g., a base station 140) may be implemented in an aggregated (e.g., monolithic, standalone) base station architecture, which may be configured to utilize a protocol stack that is physically or logically integrated within a single network entity 105 (e.g., a single RAN node, such as a base station 140).

In some examples, a network entity 105 may be implemented in a disaggregated architecture (e.g., a disaggregated base station architecture, a disaggregated RAN architecture), which may be configured to utilize a protocol stack that is physically or logically distributed among two or more network entities 105, such as an integrated access backhaul (IAB) network, an open RAN (O-RAN) (e.g., a network configuration sponsored by the O-RAN Alliance), or a virtualized RAN (vRAN) (e.g., a cloud RAN (C-RAN)). For example, a network entity 105 may include one or more of a central unit (CU) 160, a distributed unit (DU) 165, a radio unit (RU) 170, a RAN Intelligent Controller (RIC) 175 (e.g., a Near-Real Time RIC (Near-RT RIC), a Non-Real Time RIC (Non-RT RIC)), a Service Management and Orchestration (SMO) 180 system, or any combination thereof. An RU 170 may also be referred to as a radio head, a smart radio head, a remote radio head (RRH), a remote radio unit (RRU), or a transmission reception point (TRP). One or more components of the network entities 105 in a disaggregated RAN architecture may be co-located, or one or more components of the network entities 105 may be located in distributed locations (e.g., separate physical locations). In some examples, one or more network entities 105 of a disaggregated RAN architecture may be implemented as virtual units (e.g., a virtual CU (VCU), a virtual DU (VDU), a virtual RU (VRU)).

The split of functionality between a CU 160, a DU 165, and an RU 170 is flexible and may support different functionalities depending on which functions (e.g., network layer functions, protocol layer functions, baseband functions, RF functions, and any combinations thereof) are performed at a CU 160, a DU 165, or an RU 170. For example, a functional split of a protocol stack may be employed between a CU 160 and a DU 165 such that the CU 160 may support one or more layers of the protocol stack and the DU 165 may support one or more different layers of the protocol stack. In some examples, the CU 160 may host upper protocol layer (e.g., layer 3 (L3), layer 2 (L2)) functionality and signaling (e.g., Radio Resource Control (RRC), service data adaption protocol (SDAP), Packet Data Convergence Protocol (PDCP)). The CU 160 may be connected to one or more DUs 165 or RUs 170, and the one or more DUs 165 or RUS 170 may host lower protocol layers, such as layer 1 (L1) (e.g., physical (PHY) layer) or L2 (e.g., radio link control (RLC) layer, MAC layer) functionality and signaling, and may each be at least partially controlled by the CU 160. Additionally, or alternatively, a functional split of the protocol stack may be employed between a DU 165 and an RU 170 such that the DU 165 may support one or more layers of the protocol stack and the RU 170 may support one or more different layers of the protocol stack. The DU 165 may support one or multiple different cells (e.g., via one or more RUs 170). In some cases, a functional split between a CU 160 and a DU 165, or between a DU 165 and an RU 170 may be within a protocol layer (e.g., some functions for a protocol layer may be performed by one of a CU 160, a DU 165, or an RU 170, while other functions of the protocol layer are performed by a different one of the CU 160, the DU 165, or the RU 170). A CU 160 may be functionally split further into CU control plane (CU-CP) and CU user plane (CU-UP) functions. A CU 160 may be connected to one or more DUs 165 via a midhaul communication link 162 (e.g., F1, F1-c, F1-u), and a DU 165 may be connected to one or more RUs 170 via a fronthaul communication link 168 (e.g., open fronthaul (FH) interface). In some examples, a midhaul communication link 162 or a fronthaul communication link 168 may be implemented in accordance with an interface (e.g., a channel) between layers of a protocol stack supported by respective network entities 105 that are in communication via such communication links.

In wireless communications systems (e.g., wireless communications system 100), infrastructure and spectral resources for radio access may support wireless backhaul link capabilities to supplement wired backhaul connections, providing an IAB network architecture (e.g., to a core network 130). In some cases, in an IAB network, one or more network entities 105 (e.g., IAB nodes 104) may be partially controlled by each other. One or more IAB nodes 104 may be referred to as a donor entity or an IAB donor. One or more DUs 165 or one or more RUs 170 may be partially controlled by one or more CUs 160 associated with a donor network entity 105 (e.g., a donor base station 140). The one or more donor network entities 105 (e.g., IAB donors) may be in communication with one or more additional network entities 105 (e.g., IAB nodes 104) via supported access and backhaul links (e.g., backhaul communication links 120). IAB nodes 104 may include an IAB mobile termination (IAB-MT) controlled (e.g., scheduled) by DUs 165 of a coupled IAB donor. An IAB-MT may include an independent set of antennas for relay of communications with UEs 115, or may share the same antennas (e.g., of an RU 170) of an IAB node 104 used for access via the DU 165 of the IAB node 104 (e.g., referred to as virtual IAB-MT (vIAB-MT)). In some examples, the IAB nodes 104 may include DUs 165 that support communication links with additional entities (e.g., IAB nodes 104, UEs 115) within the relay chain or configuration of the access network (e.g., downstream). In such cases, one or more components of the disaggregated RAN architecture (e.g., one or more IAB nodes 104 or components of IAB nodes 104) may be configured to operate according to the techniques described herein.

For instance, an access network (AN) or RAN may include communications between access nodes (e.g., an IAB donor), IAB nodes 104, and one or more UEs 115. The IAB donor may facilitate connection between the core network 130 and the AN (e.g., via a wired or wireless connection to the core network 130). That is, an IAB donor may refer to a RAN node with a wired or wireless connection to core network 130. The IAB donor may include a CU 160 and at least one DU 165 (e.g., and RU 170), in which case the CU 160 may communicate with the core network 130 via an interface (e.g., a backhaul link). IAB donor and IAB nodes 104 may communicate via an F1 interface according to a protocol that defines signaling messages (e.g., an F1 AP protocol). Additionally, or alternatively, the CU 160 may communicate with the core network via an interface, which may be an example of a portion of backhaul link, and may communicate with other CUs 160 (e.g., a CU 160 associated with an alternative IAB donor) via an Xn-C interface, which may be an example of a portion of a backhaul link.

An IAB node 104 may refer to a RAN node that provides IAB functionality (e.g., access for UEs 115, wireless self-backhauling capabilities). A DU 165 may act as a distributed scheduling node towards child nodes associated with the IAB node 104, and the IAB-MT may act as a scheduled node towards parent nodes associated with the IAB node 104. That is, an IAB donor may be referred to as a parent node in communication with one or more child nodes (e.g., an IAB donor may relay transmissions for UEs through one or more other IAB nodes 104). Additionally, or alternatively, an IAB node 104 may also be referred to as a parent node or a child node to other IAB nodes 104, depending on the relay chain or configuration of the AN. Therefore, the IAB-MT entity of IAB nodes 104 may provide a Uu interface for a child IAB node 104 to receive signaling from a parent IAB node 104, and the DU interface (e.g., DUs 165) may provide a Uu interface for a parent IAB node 104 to signal to a child IAB node 104 or UE 115.

For example, IAB node 104 may be referred to as a parent node that supports communications for a child IAB node, or referred to as a child IAB node associated with an IAB donor, or both. The IAB donor may include a CU 160 with a wired or wireless connection (e.g., a backhaul communication link 120) to the core network 130 and may act as parent node to IAB nodes 104. For example, the DU 165 of IAB donor may relay transmissions to UEs 115 through IAB nodes 104, or may directly signal transmissions to a UE 115, or both. The CU 160 of IAB donor may signal communication link establishment via an F1 interface to IAB nodes 104, and the IAB nodes 104 may schedule transmissions (e.g., transmissions to the UEs 115 relayed from the IAB donor) through the DUs 165. That is, data may be relayed to and from IAB nodes 104 via signaling via an NR Uu interface to MT of the IAB node 104. Communications with IAB node 104 may be scheduled by a DU 165 of IAB donor and communications with IAB node 104 may be scheduled by DU 165 of IAB node 104.

In the case of the techniques described herein applied in the context of a disaggregated RAN architecture, one or more components of the disaggregated RAN architecture may be configured to support cross-serving cell predictive beam management as described herein. For example, some operations described as being performed by a UE 115 or a network entity 105 (e.g., a base station 140) may additionally, or alternatively, be performed by one or more components of the disaggregated RAN architecture (e.g., IAB nodes 104, DUs 165, CUs 160, RUs 170, RIC 175, SMO 180).

A UE 115 may include or may be referred to as a mobile device, a wireless device, a remote device, a handheld device, or a subscriber device, or some other suitable terminology, where the “device” may also be referred to as a unit, a station, a terminal, or a client, among other examples. A UE 115 may also include or may be referred to as a personal electronic device such as a cellular phone, a personal digital assistant (PDA), a multimedia/entertainment device (e.g., a radio, a MP3 player, or a video device), a camera, a gaming device, a navigation/positioning device (e.g., GNSS (global navigation satellite system) devices based on, for example, GPS (global positioning system), Beidou, GLONASS, or Galileo, or a terrestrial-based device), a tablet computer, a laptop computer, a netbook, a smartbook, a personal computer, a smart device, a wearable device (e.g., a smart watch, smart clothing, smart glasses, virtual reality goggles, a smart wristband, smart jewelry (e.g., a smart ring, a smart bracelet)), a drone, a robot/robotic device, a vehicle, a vehicular device, a meter (e.g., parking meter, electric meter, gas meter, water meter), a monitor, a gas pump, an appliance (e.g., kitchen appliance, washing machine, dryer), a location tag, a medical/healthcare device, an implant, a sensor/actuator, a display, or any other suitable device configured to communicate via a wireless or wired medium. In some examples, a UE 115 may include or be referred to as a wireless local loop (WLL) station, an Internet of Things (IoT) device, an Internet of Everything (IoE) device, or a machine type communications (MTC) device, among other examples, which may be implemented in various objects such as appliances, or vehicles, meters, among other examples.

The UEs 115 described herein may be able to communicate with various types of devices, such as other UEs 115 that may sometimes act as relays as well as the network entities 105 and the network equipment including macro eNBs or gNBs, small cell eNBs or gNBs, or relay base stations, among other examples, as shown in FIG. 1.

The UEs 115 and the network entities 105 may wirelessly communicate with one another via one or more communication links 125 (e.g., an access link) using resources associated with one or more carriers. The term “carrier” may refer to a set of RF spectrum resources having a defined physical layer structure for supporting the communication links 125. For example, a carrier used for a communication link 125 may include a portion of a RF spectrum band (e.g., a bandwidth part (BWP)) that is operated according to one or more physical layer channels for a given radio access technology (e.g., LTE, LTE-A, LTE-A Pro, NR). Each physical layer channel may carry acquisition signaling (e.g., synchronization signals, system information), control signaling that coordinates operation for the carrier, user data, or other signaling. The wireless communications system 100 may support communication with a UE 115 using carrier aggregation or multi-carrier operation. A UE 115 may be configured with multiple downlink component carriers and one or more uplink component carriers according to a carrier aggregation configuration. Carrier aggregation may be used with both frequency division duplexing (FDD) and time division duplexing (TDD) component carriers. Communication between a network entity 105 and other devices may refer to communication between the devices and any portion (e.g., entity, sub-entity) of a network entity 105. For example, the terms “transmitting,” “receiving,” or “communicating,” when referring to a network entity 105, may refer to any portion of a network entity 105 (e.g., a base station 140, a CU 160, a DU 165, a RU 170) of a RAN communicating with another device (e.g., directly or via one or more other network entities 105).

Signal waveforms transmitted via a carrier may be made up of multiple subcarriers (e.g., using multi-carrier modulation (MCM) techniques such as orthogonal frequency division multiplexing (OFDM) or discrete Fourier transform spread OFDM (DFT-S-OFDM)). In a system employing MCM techniques, a resource element may refer to resources of one symbol period (e.g., a duration of one modulation symbol) and one subcarrier, in which case the symbol period and subcarrier spacing may be inversely related. The quantity of bits carried by each resource element may depend on the modulation scheme (e.g., the order of the modulation scheme, the coding rate of the modulation scheme, or both), such that a relatively higher quantity of resource elements (e.g., in a transmission duration) and a relatively higher order of a modulation scheme may correspond to a relatively higher rate of communication. A wireless communications resource may refer to a combination of an RF spectrum resource, a time resource, and a spatial resource (e.g., a spatial layer, a beam), and the use of multiple spatial resources may increase the data rate or data integrity for communications with a UE 115.

The time intervals for the network entities 105 or the UEs 115 may be expressed in multiples of a basic time unit which may, for example, refer to a sampling period of Tₛ=1/(Δfₘₐₓ·N_{f}) seconds, for which Δfₘₐₓ may represent a supported subcarrier spacing, and N_{f} may represent a supported discrete Fourier transform (DFT) size. Time intervals of a communications resource may be organized according to radio frames each having a specified duration (e.g., 10 milliseconds (ms)). Each radio frame may be identified by a system frame number (SFN) (e.g., ranging from 0 to 1023).

Each frame may include multiple consecutively numbered subframes or slots, and each subframe or slot may have the same duration. In some examples, a frame may be divided (e.g., in the time domain) into subframes, and each subframe may be further divided into a quantity of slots. Alternatively, each frame may include a variable quantity of slots, and the quantity of slots may depend on subcarrier spacing. Each slot may include a quantity of symbol periods (e.g., depending on the length of the cyclic prefix prepended to each symbol period). In some wireless communications systems 100, a slot may further be divided into multiple mini-slots associated with one or more symbols. Excluding the cyclic prefix, each symbol period may be associated with one or more (e.g., N_{f}) sampling periods. The duration of a symbol period may depend on the subcarrier spacing or frequency band of operation.

A subframe, a slot, a mini-slot, or a symbol may be the smallest scheduling unit (e.g., in the time domain) of the wireless communications system 100 and may be referred to as a transmission time interval (TTI). In some examples, the TTI duration (e.g., a quantity of symbol periods in a TTI) may be variable. Additionally, or alternatively, the smallest scheduling unit of the wireless communications system 100 may be dynamically selected (e.g., in bursts of shortened TTIs (sTTIs)).

Physical channels may be multiplexed for communication using a carrier according to various techniques. A physical control channel and a physical data channel may be multiplexed for signaling via a downlink carrier, for example, using one or more of time division multiplexing (TDM) techniques, frequency division multiplexing (FDM) techniques, or hybrid TDM-FDM techniques. A control region (e.g., a control resource set (CORESET)) for a physical control channel may be defined by a set of symbol periods and may extend across the system bandwidth or a subset of the system bandwidth of the carrier. One or more control regions (e.g., CORESETs) may be configured for a set of the UEs 115. For example, one or more of the UEs 115 may monitor or search control regions for control information according to one or more search space sets, and each search space set may include one or multiple control channel candidates in one or more aggregation levels arranged in a cascaded manner. An aggregation level for a control channel candidate may refer to an amount of control channel resources (e.g., control channel elements (CCEs)) associated with encoded information for a control information format having a given payload size. Search space sets may include common search space sets configured for sending control information to multiple UEs 115 and UE-specific search space sets for sending control information to a specific UE 115.

A network entity 105 may provide communication coverage via one or more cells, for example a macro cell, a small cell, a hot spot, or other types of cells, or any combination thereof. The term “cell” may refer to a logical communication entity used for communication with a network entity 105 (e.g., using a carrier) and may be associated with an identifier for distinguishing neighboring cells (e.g., a physical cell identifier (PCID), a virtual cell identifier (VCID), or others). In some examples, a cell also may refer to a coverage area 110 or a portion of a coverage area 110 (e.g., a sector) over which the logical communication entity operates. Such cells may range from smaller areas (e.g., a structure, a subset of structure) to larger areas depending on various factors such as the capabilities of the network entity 105. For example, a cell may be or include a building, a subset of a building, or exterior spaces between or overlapping with coverage areas 110, among other examples.

A macro cell generally covers a relatively large geographic area (e.g., several kilometers in radius) and may allow unrestricted access by the UEs 115 with service subscriptions with the network provider supporting the macro cell. A small cell may be associated with a lower-powered network entity 105 (e.g., a lower-powered base station 140), as compared with a macro cell, and a small cell may operate using the same or different (e.g., licensed, unlicensed) frequency bands as macro cells. Small cells may provide unrestricted access to the UEs 115 with service subscriptions with the network provider or may provide restricted access to the UEs 115 having an association with the small cell (e.g., the UEs 115 in a closed subscriber group (CSG), the UEs 115 associated with users in a home or office). A network entity 105 may support one or multiple cells and may also support communications via the one or more cells using one or multiple component carriers.

In some examples, a carrier may support multiple cells, and different cells may be configured according to different protocol types (e.g., MTC, narrowband IoT (NB-IoT), enhanced mobile broadband (eMBB)) that may provide access for different types of devices.

In some examples, a network entity 105 (e.g., a base station 140, an RU 170) may be movable and therefore provide communication coverage for a moving coverage area 110. In some examples, different coverage areas 110 associated with different technologies may overlap, but the different coverage areas 110 may be supported by the same network entity 105. In some other examples, the overlapping coverage areas 110 associated with different technologies may be supported by different network entities 105. The wireless communications system 100 may include, for example, a heterogeneous network in which different types of the network entities 105 provide coverage for various coverage areas 110 using the same or different radio access technologies.

The wireless communications system 100 may support synchronous or asynchronous operation. For synchronous operation, network entities 105 (e.g., base stations 140) may have similar frame timings, and transmissions from different network entities 105 may be approximately aligned in time. For asynchronous operation, network entities 105 may have different frame timings, and transmissions from different network entities 105 may, in some examples, not be aligned in time. The techniques described herein may be used for either synchronous or asynchronous operations.

The wireless communications system 100 may be configured to support ultra-reliable communications or low-latency communications, or various combinations thereof. For example, the wireless communications system 100 may be configured to support ultra-reliable low-latency communications (URLLC). The UEs 115 may be designed to support ultra-reliable, low-latency, or critical functions. Ultra-reliable communications may include private communication or group communication and may be supported by one or more services such as push-to-talk, video, or data. Support for ultra-reliable, low-latency functions may include prioritization of services, and such services may be used for public safety or general commercial applications. The terms ultra-reliable, low-latency, and ultra-reliable low-latency may be used interchangeably herein.

In some examples, a UE 115 may be configured to support communicating directly with other UEs 115 via a device-to-device (D2D) communication link 135 (e.g., in accordance with a peer-to-peer (P2P), D2D, or sidelink protocol). In some examples, one or more UEs 115 of a group that are performing D2D communications may be within the coverage area 110 of a network entity 105 (e.g., a base station 140, an RU 170), which may support aspects of such D2D communications being configured by (e.g., scheduled by) the network entity 105. In some examples, one or more UEs 115 of such a group may be outside the coverage area 110 of a network entity 105 or may be otherwise unable to or not configured to receive transmissions from a network entity 105. In some examples, groups of the UEs 115 communicating via D2D communications may support a one-to-many (1:M) system in which each UE 115 transmits to each of the other UEs 115 in the group. In some examples, a network entity 105 may facilitate the scheduling of resources for D2D communications. In some other examples, D2D communications may be carried out between the UEs 115 without an involvement of a network entity 105.

The core network 130 may provide user authentication, access authorization, tracking, Internet Protocol (IP) connectivity, and other access, routing, or mobility functions. The core network 130 may be an evolved packet core (EPC) or 5G core (5GC), which may include at least one control plane entity that manages access and mobility (e.g., a mobility management entity (MME), an access and mobility management function (AMF)) and at least one user plane entity that routes packets or interconnects to external networks (e.g., a serving gateway (S-GW), a Packet Data Network (PDN) gateway (P-GW), or a user plane function (UPF)). The control plane entity may manage non-access stratum (NAS) functions such as mobility, authentication, and bearer management for the UEs 115 served by the network entities 105 (e.g., base stations 140) associated with the core network 130. User IP packets may be transferred through the user plane entity, which may provide IP address allocation as well as other functions. The user plane entity may be connected to IP services 150 for one or more network operators. The IP services 150 may include access to the Internet, Intranet(s), an IP Multimedia Subsystem (IMS), or a Packet-Switched Streaming Service.

The wireless communications system 100 may operate using one or more frequency bands, which may be in the range of 300 megahertz (MHz) to 300 gigahertz (GHz). Generally, the region from 300 MHz to 3 GHz is known as the ultra-high frequency (UHF) region or decimeter band because the wavelengths range from approximately one decimeter to one meter in length. UHF waves may be blocked or redirected by buildings and environmental features, which may be referred to as clusters, but the waves may penetrate structures sufficiently for a macro cell to provide service to the UEs 115 located indoors. Communications using UHF waves may be associated with smaller antennas and shorter ranges (e.g., less than 100 kilometers) compared to communications using the smaller frequencies and longer waves of the high frequency (HF) or very high frequency (VHF) portion of the spectrum below 300 MHZ.

The wireless communications system 100 may utilize both licensed and unlicensed RF spectrum bands. For example, the wireless communications system 100 may employ License Assisted Access (LAA), LTE-Unlicensed (LTE-U) radio access technology, or NR technology using an unlicensed band such as the 5 GHz industrial, scientific, and medical (ISM) band. While operating using unlicensed RF spectrum bands, devices such as the network entities 105 and the UEs 115 may employ carrier sensing for collision detection and avoidance. In some examples, operations using unlicensed bands may be based on a carrier aggregation configuration in conjunction with component carriers operating using a licensed band (e.g., LAA). Operations using unlicensed spectrum may include downlink transmissions, uplink transmissions, P2P transmissions, or D2D transmissions, among other examples.

A network entity 105 (e.g., a base station 140, an RU 170) or a UE 115 may be equipped with multiple antennas, which may be used to employ techniques such as transmit diversity, receive diversity, multiple-input multiple-output (MIMO) communications, or beamforming. The antennas of a network entity 105 or a UE 115 may be located within one or more antenna arrays or antenna panels, which may support MIMO operations or transmit or receive beamforming. For example, one or more base station antennas or antenna arrays may be co-located at an antenna assembly, such as an antenna tower. In some examples, antennas or antenna arrays associated with a network entity 105 may be located at diverse geographic locations. A network entity 105 may include an antenna array with a set of rows and columns of antenna ports that the network entity 105 may use to support beamforming of communications with a UE 115. Likewise, a UE 115 may include one or more antenna arrays that may support various MIMO or beamforming operations. Additionally, or alternatively, an antenna panel may support RF beamforming for a signal transmitted via an antenna port.

The network entities 105 or the UEs 115 may use MIMO communications to exploit multipath signal propagation and increase spectral efficiency by transmitting or receiving multiple signals via different spatial layers. Such techniques may be referred to as spatial multiplexing. The multiple signals may, for example, be transmitted by the transmitting device via different antennas or different combinations of antennas. Likewise, the multiple signals may be received by the receiving device via different antennas or different combinations of antennas. Each of the multiple signals may be referred to as a separate spatial stream and may carry information associated with the same data stream (e.g., the same codeword) or different data streams (e.g., different codewords). Different spatial layers may be associated with different antenna ports used for channel measurement and reporting. MIMO techniques include single-user MIMO (SU-MIMO), for which multiple spatial layers are transmitted to the same receiving device, and multiple-user MIMO (MU-MIMO), for which multiple spatial layers are transmitted to multiple devices.

Beamforming, which may also be referred to as spatial filtering, directional transmission, or directional reception, is a signal processing technique that may be used at a transmitting device or a receiving device (e.g., a network entity 105, a UE 115) to shape or steer an antenna beam (e.g., a transmit beam, a receive beam) along a spatial path between the transmitting device and the receiving device. Beamforming may be achieved by combining the signals communicated via antenna elements of an antenna array such that some signals propagating along particular orientations with respect to an antenna array experience constructive interference while others experience destructive interference. The adjustment of signals communicated via the antenna elements may include a transmitting device or a receiving device applying amplitude offsets, phase offsets, or both to signals carried via the antenna elements associated with the device. The adjustments associated with each of the antenna elements may be defined by a beamforming weight set associated with a particular orientation (e.g., with respect to the antenna array of the transmitting device or receiving device, or with respect to some other orientation).

A network entity 105 or a UE 115 may use beam sweeping techniques as part of beamforming operations. For example, a network entity 105 (e.g., a base station 140, an RU 170) may use multiple antennas or antenna arrays (e.g., antenna panels) to conduct beamforming operations for directional communications with a UE 115. Some signals (e.g., synchronization signals, reference signals, beam selection signals, or other control signals) may be transmitted by a network entity 105 multiple times along different directions. For example, the network entity 105 may transmit a signal according to different beamforming weight sets associated with different directions of transmission. Transmissions along different beam directions may be used to identify (e.g., by a transmitting device, such as a network entity 105, or by a receiving device, such as a UE 115) a beam direction for later transmission or reception by the network entity 105.

Some signals, such as data signals associated with a particular receiving device, may be transmitted by transmitting device (e.g., a transmitting network entity 105, a transmitting UE 115) along a single beam direction (e.g., a direction associated with the receiving device, such as a receiving network entity 105 or a receiving UE 115). In some examples, the beam direction associated with transmissions along a single beam direction may be determined based on a signal that was transmitted along one or more beam directions. For example, a UE 115 may receive one or more of the signals transmitted by the network entity 105 along different directions and may report to the network entity 105 an indication of the signal that the UE 115 received with a highest signal quality or an otherwise acceptable signal quality.

In some examples, transmissions by a device (e.g., by a network entity 105 or a UE 115) may be performed using multiple beam directions, and the device may use a combination of digital precoding or beamforming to generate a combined beam for transmission (e.g., from a network entity 105 to a UE 115). The UE 115 may report feedback that indicates precoding weights for one or more beam directions, and the feedback may correspond to a configured set of beams across a system bandwidth or one or more sub-bands. The network entity 105 may transmit a reference signal (e.g., a cell-specific reference signal (CRS), a CSI reference signal (CSI-RS)), which may be precoded or unprecoded. The UE 115 may provide feedback for beam selection, which may be a precoding matrix indicator (PMI) or codebook-based feedback (e.g., a multi-panel type codebook, a linear combination type codebook, a port selection type codebook). Although these techniques are described with reference to signals transmitted along one or more directions by a network entity 105 (e.g., a base station 140, an RU 170), a UE 115 may employ similar techniques for transmitting signals multiple times along different directions (e.g., for identifying a beam direction for subsequent transmission or reception by the UE 115) or for transmitting a signal along a single direction (e.g., for transmitting data to a receiving device).

A receiving device (e.g., a UE 115) may perform reception operations in accordance with multiple receive configurations (e.g., directional listening) when receiving various signals from a receiving device (e.g., a network entity 105), such as synchronization signals, reference signals, beam selection signals, or other control signals. For example, a receiving device may perform reception in accordance with multiple receive directions by receiving via different antenna subarrays, by processing received signals according to different antenna subarrays, by receiving according to different receive beamforming weight sets (e.g., different directional listening weight sets) applied to signals received at multiple antenna elements of an antenna array, or by processing received signals according to different receive beamforming weight sets applied to signals received at multiple antenna elements of an antenna array, any of which may be referred to as “listening” according to different receive configurations or receive directions. In some examples, a receiving device may use a single receive configuration to receive along a single beam direction (e.g., when receiving a data signal). The single receive configuration may be aligned along a beam direction determined based on listening according to different receive configuration directions (e.g., a beam direction determined to have a highest signal strength, highest signal-to-noise ratio (SNR), or otherwise acceptable signal quality based on listening according to multiple beam directions).

The wireless communications system 100 may be a packet-based network that operates according to a layered protocol stack. In the user plane, communications at the bearer or PDCP layer may be IP-based. An RLC layer may perform packet segmentation and reassembly to communicate via logical channels. A MAC layer may perform priority handling and multiplexing of logical channels into transport channels. The MAC layer also may implement error detection techniques, error correction techniques, or both to support retransmissions to improve link efficiency. In the control plane, an RRC layer may provide establishment, configuration, and maintenance of an RRC connection between a UE 115 and a network entity 105 or a core network 130 supporting radio bearers for user plane data. A PHY layer may map transport channels to physical channels.

The wireless communications system 100 may support various communication procedures. A UE 115 may start in an RRC idle state or an RRC inactive state. The UE 115 may perform an initial access with a network entity 105. The initial access may include synchronization signal blocks (SSBs), beam sweeping, contention-based random access (CBRA), RACH procedures (e.g., occasions, preambles), or any combination thereof. The UE 115 and the network entity 105 in an RRC connected state, based on a successful initial access, may perform beam management procedures. For example, beam management procedures may support layer 1 (L1)-signal to interference plus noise ratio (SINR) reporting, L1-reference signal received power (RSRP) reporting, overhead and latency reduction (e.g., component carrier aggregation group beam update, efficient uplink beam update), latency and efficiency enhancements (e.g., unified transmission configuration indicator (TCI) states, L1 and layer 2 (L2)-centric mobility, dynamic TCI update, uplink multi-panel selection, maximum power extrapolation (MPE) mitigation, or any combination thereof.

In the RRC connected state, the UE 115 may perform beam failure detection based on channel quality measurements or beam measurements. Based on detecting one or more failed beams, the UE 115 may perform beam failure recovery. For example, the UE 115 may perform beam failure detection, beam failure recovery, or both, for primary cells (PCells), primary and secondary cells (PSCells), or secondary cells (SCells) using reference signals, physical downlink control channel (PDCCH) block error rate (BLER), contention-free random access (FRA), link recovery requests, MAC-CE, or any combination thereof. In some cases, the UE 115 may perform fast recovery and restart beam management procedures. In other cases, the UE 115 may determine a radio link failure.

The wireless communications system 100 may support beam management, beam prediction in time, spatial domain for overhead and latency reduction, beam selection accuracy improvement, or any combination thereof. In some cases, the wireless communications system 100 may utilize artificial intelligence or machine learning techniques. The wireless communications system 100 may perform model training, model deployment, model inference, model monitoring, model updating, or a combination thereof, on an AI or ML model to assist in wireless communications methods.

The wireless communications system 100 may implement L1 or L2-based inter-cell mobility, and the examples described herein may support mobility latency reduction. For example, the wireless communications system 100 may support configuration and maintenance for multiple candidate cells to allow efficient application of configurations for candidate cells. In some examples, the wireless communications system 100 may support dynamic switch mechanisms among candidate serving cells (e.g., PCells, SCells, PSCells), which may be based on L1 or L2 signaling. The wireless communications system 100 may support CU-DU interface signaling to support L1 and or L2-based inter-cell mobility. In some cases, the wireless communications system 100 may support multi-radio access technology dual connectivity (MR-DC) procedures with selective activation of cell groups via layer 3 enhancements (e.g., to allow continuous packet connectivity (CPC), conditional PSCell Addition and Change (CPAC) after changing secondary cell group (SCG) without reconfiguration and re-initiation of CPC or CPAC).

The wireless communications system 100 may support enhancements in conditional handover including a target master cell group (MCG), a target secondary cell group (SCG), or any combination thereof. The conditional handover may include a target MCG and candidate SCG for CPC or CPAC. The conditional handover may include a target MCH and a target SCG used as a baseline. In some examples, the wireless communications system 100 may support configuration and operation of LTE-like mobile broadband, handover procedures without RACH, or a combination thereof.

In some examples, a UE 115 may receive, from a first serving cell (e.g., via a first network entity 105), control signaling indicating a cross serving cell scheme that identifies a first set of resources of a second serving cell (e.g., associated with a second network entity 105) that are associated with a second set of resources of the second serving cell. The first set of resources may be for measuring channel quality for a first set of beams, and the second set of resources may be for predicting channel quality for a second set of beams. The UE 115 may perform channel measurements via the first set of resources using the first set of beams according to the cross serving cell scheme. In some cases, the UE 115 may transmit, to the first serving cell (e.g., to the first network entity 105) based on the one or more channel measurements and the cross serving cell scheme, a CSI report indicating predicted channel quality information for the second set of resources for the second set of beams associated with the second serving cell.

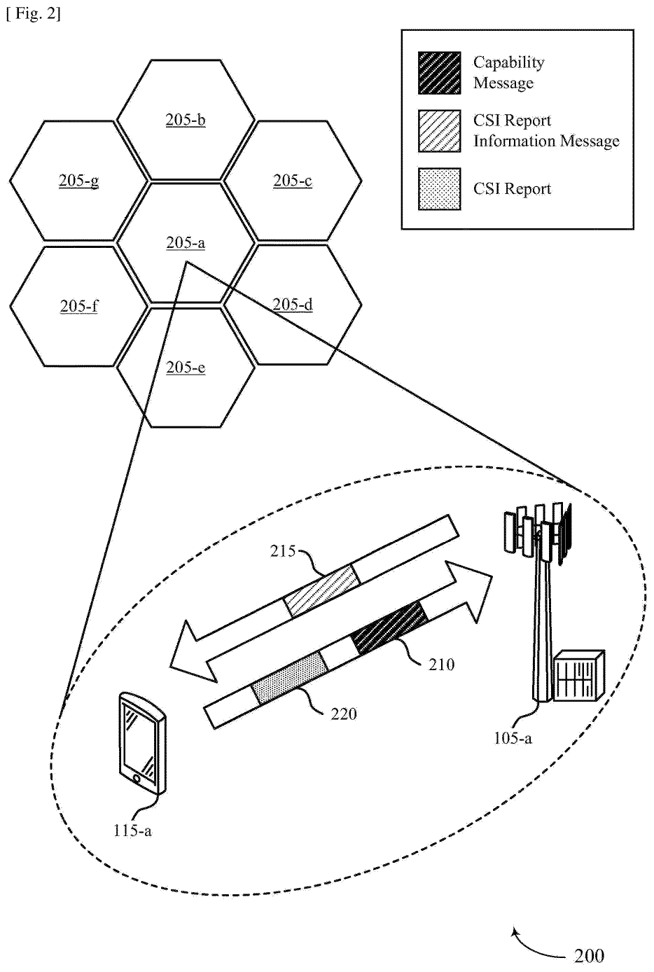

FIG. 2 illustrates an example of a wireless communications system 200 that supports cross-serving cell predictive beam management in accordance with one or more aspects of the present disclosure. The wireless communications system 200 may implement or may be implemented by aspects of the wireless communications system 100. For example, the wireless communications system 200 may include a UE 115-a and a network entity 105-a, which may be examples of corresponding devices described with reference to FIG. 1.

In some examples, the UE 115-a may be located in the serving cell 205-a (e.g., within a geographic coverage area associated with the serving cell 205-a). In some examples, the network entity 105-a may be located within the serving cell 205-a. The network entity 105-a may correspond to each serving cell 205, or each serving cell 205 may correspond to a different network entity 105 (e.g., each of serving cell 205-b, serving cell 205-c, serving cell 205-d, serving cell 205-e, serving cell 205-f, serving cell 205-g, may correspond to a respective network entity 105).

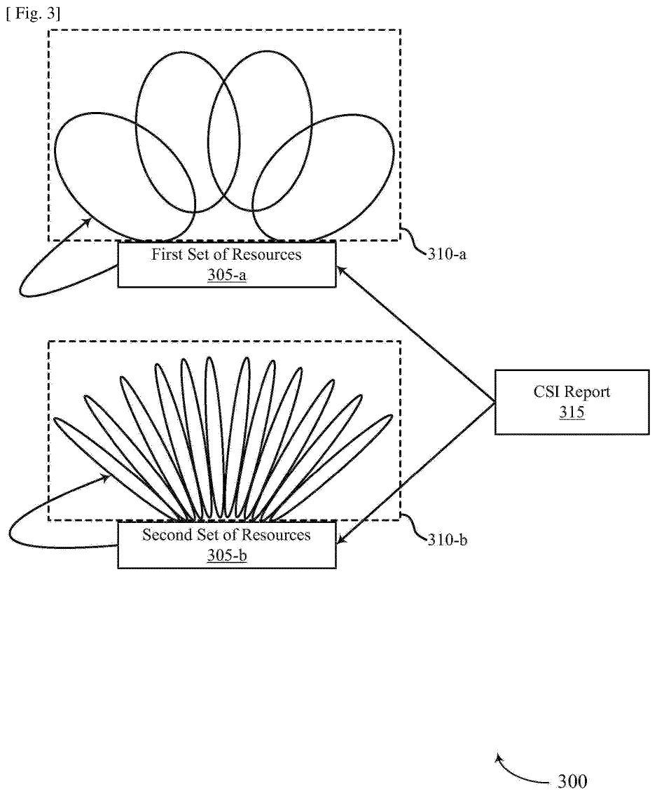

In some examples, the UE 115-a may perform one or more channel quality measurements, and may transmit the CSI report 220 indicating the one or more channel quality measurements to the network entity 105-a. The network entity 105-a may configure the UE 115-a (e.g., via the CSI report information message 215) with resources on which to perform the one or more channel quality measurements, beams on which to monitor for CSI-RSs, or a combination thereof. In some examples, as described in greater detail with reference to FIG. 3, the network entity 105-a may configure the UE 115-a with a first set of resources and a second set of resources. The first set of resources may correspond to a first set of beams (set A), and the network entity 105-a may configure the UE 115-a to perform channel measurements via the first set of resources using the first set of beams. The second set of resources may be virtual resources, and the network entity 105-a may configure the UE 115-a to perform channel measurement predictions (e.g., indicate predicted channel measurements via the CSI report 220) via the second set of resources using the second set of beams (set B). The UE 115-a may include the channel measurements for set A and the predicted channel measurements for set B in the CSI report 220.

In some cases, the UE 115-a may be mobile and may switch from the serving cell 205-a to a different serving cell. For example, the UE 115-a may switch from the serving cell 205-a to the serving cell 205-b, and channel measurements or channel measurement predictions that the UE performs in the serving cell 205-a may not be applicable for communications within the serving cell 205-b, or channel measurement performed with reference to serving cell 205-a may be relevant, but not provided to, another serving cell 205 (e.g., resulting in inefficient additional measurements or inefficient reporting).

Examples described herein may support layer 1 (L1) beam reporting for non-serving cells in cases where the UE 115-a switches from an LI serving cell to a layer 2 (L2) serving cell. The UE 115-a may support LI enhancements including inter-cell beam management, L1 measurement and reporting, beam indication, time advance (TA) management (e.g., in a non-synchronized case), or a combination thereof. In some cases, the UE 115-a or the network entity 105-a may be aware that the UE 115-a may be moving to the serving cell 205-b or may operate in the serving cell 205-b at a later time. In such cases, it may be beneficial for the UE 115-a to perform measurements and predicted beam measurements for resources within the serving cell 205-b while the UE 115-a is within the serving cell 205-a. For example, the UE 115-a may switch from the serving cell 205-a to the serving cell 205-b, and the UE 115-a may use the predicted beam measurements for resources within the serving cell 205-b to communicate in the serving cell 205-b.

Thus, the UE 115-a may support a mobile latency reduction. That is, the UE 115-a may reduce a delay or latency associated with switching between the serving cell 205-a and the serving cell 205-b. For example, the UE 115-a may switch (e.g., move) to the serving cell 205-b. If beams on which the UE 115-a is currently (e.g., or previously) communicating are no longer valid in the serving cell 205-b, then initiating a new beam sweeping procedure or performing new CSI measurements and CSI reporting may take additional time, resulting in increased latency, failed communications, or a communication gap (e.g., due to a beam direction or interference in the serving cell 205-b). In some examples, the beams on which the UE 115-a is currently (e.g., or was previously) communicating may continue to be valid for the cell 205-b. However, re-performing beam selection or CSI measurements and CSI reporting (e.g., when the current or previous beams used by the UE 115-a may also function for communications in the serving cell 205-b), may result in unnecessary and inefficient delays. According to techniques described herein, rather than perform new measurements after switching to serving cell 205-b, which may cause latency in communication with the network entity 105-a (e.g., or another network entity 105), the UE 115-a may utilize channel measurements of resources corresponding to the serving cell 205-b that the UE 115-a has already performed.

In accordance with the examples described herein, the network entity 105-a may transmit the CSI report information message 215 (e.g., via the first serving cell 205-a) that may indicate a first set of resources and a second set of resources associated with a second serving cell 205 (e.g., the serving cell 205-b) for the UE 115-a to perform channel quality measurements using a first set of beams corresponding to the first set of resources and channel quality predictions using a second set of beams corresponding to the second set of resources. The CSI report information message 215 may also indicate that the UE 115-a is to report predicted measurements for the second set of resources associated with the serving cell 205-b for the second set of beams. In response to the CSI report information message 215, the UE 115-a may transmit, to the network entity 105-a via the CSI report 220 within the serving cell 205-a, the predicted channel quality measurements for the second set of resources associated with the serving cell 205-b. The predicted channel quality measurements may support effective and efficient mobility for the UE 115-a (e.g., because the UE performs channel quality predictions for the cell 205-b and reports them to the serving cell 205-a, the UE may more efficiently perform mobility functions when moving from the serving cell 205-a to the serving cell 205-b based on channel quality predictions already performed and reported) In some examples, the UE 115-a may transmit a capability message 210 to the network entity 105-a that indicates a capability of the UE 115-a to support cross-serving cell predictive beam management. The capability message 210 may indicate that the UE 115-a, which is within the serving cell 205-a, is capable of predicting channel measurements for a different serving cell (e.g., the serving cell 205-b). The CSI report information message 215 may be based on the capability message 210. For example, the UE 115-a may indicate a capability of the UE 115-a for cross-serving cell predictive beam management, and the network entity 105-a may include resources associated with the serving cell 205-b in the CSI report information message 215 based on the capability of the UE 115-a.

FIG. 3 illustrates an example of a channel measurement scheme 300 that supports cross-serving cell predictive beam management in accordance with one or more aspects of the present disclosure. The channel measurement scheme 300 may implement or may be implemented by aspects of the wireless communications systems 100 and 200. For example, the channel measurement scheme 300 may include a CSI report 315, which may be an example of a CSI report 220 as described with reference to FIG. 2.

In some examples of beam management (e.g., AI-based, ML-based beam management), a network entity (e.g., the network entity 105-a) may configure a UE with two sets of beams for CSI measurement and prediction. The network entity may configure the UE with a first set of beams 310-a (e.g., set A). The UE may perform measurements on the first set of beams 310-a via the first set of resources 305-a (e.g., channel measurement resources (CMRs)). In some examples, the network entity may configure the UE with a second set of beams 310-b (e.g., set B). The UE may perform a beam prediction (e.g., spatial-domain downlink beam prediction, temporal downlink beam prediction) for the second set of beams 310-b based on measurement results, historic measurement results, or a combination thereof, of the first set of beams 310-a. In some cases, the UE may use a second set of resources 305-b (e.g., CMRs, virtual resources) to perform the beam prediction, and the second set of resources 305-b may correspond to the second set of beams 310-b. The UE may perform measurements using the set of beams 310-a and the set of beams 310-b via resources in the same frequency range or in different frequency ranges (e.g., the first set of resources 305-a and the second set of resources 305-b may partially overlap in frequency, completely overlap in frequency, may correspond to adjacent frequency ranges or frequency bands or subbands, or may be entirely different from each other).

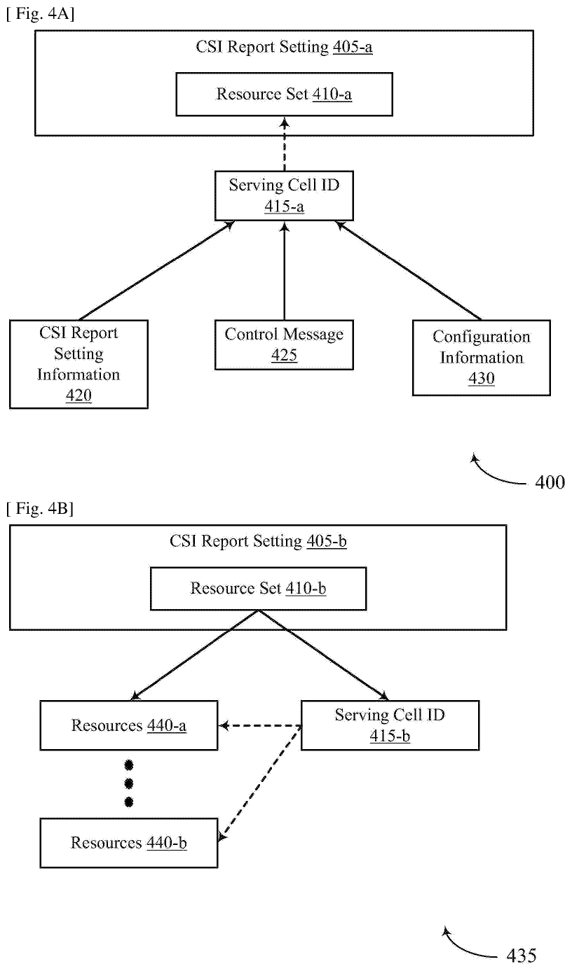

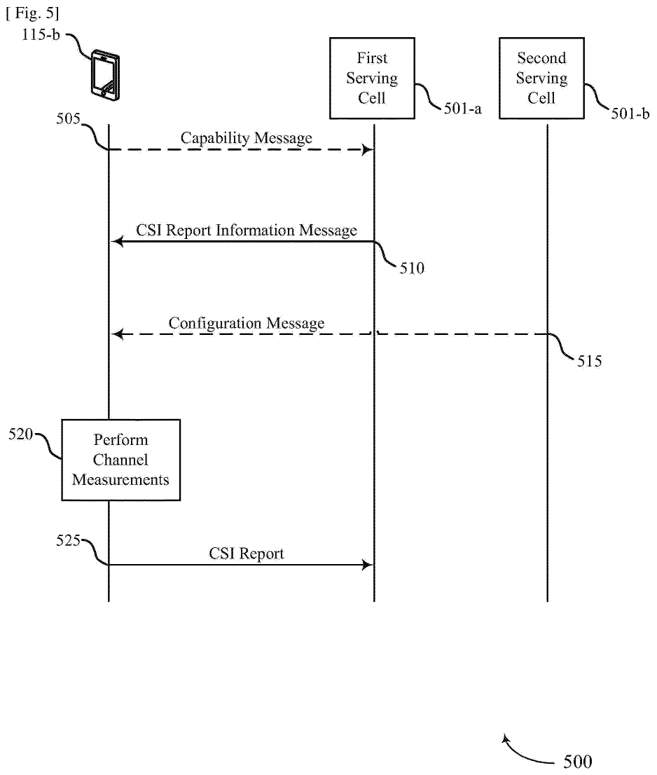

In some examples, the first set of beams 310-a may be a subset of the second set of beams 310-b. In some examples, the first set of beams 310-a may have a same quantity of beams as the second set of beams 310-b, or the sets of beams 310 may have different quantities of beams. In some cases, the set of beams 310-a may be associated with the set of beams 310-b based on a fixed pattern, a random pattern, or a quasi-colocation relationship. The set of beams 310-a may have different characteristics than the set of beams 310-b. For example, the set of beams 310-a may be wide (e.g., coarse) beams and the set of beams 310-b may be narrow (e.g., fine) beams. In some examples, subsets of beams 310-b may correspond to individual coarse beams of the set of beams 310-b (e.g., three narrow beams of the set of beams 310-b may correspond to each coarse beam of the set of beams 310-a). The set of beams 310-a may be for downlink beam measurement, and the set of beams 310-b may be for DL beam prediction. The sets of beams 310 may be indicated by codebook constructions, as described in greater detail with reference to FIGS. 4A, 4B, and 5.

In some examples, a network entity may configure a UE for a first serving cell (e.g., via RRC configuration). The configuration may include a codebook which may include sets of beams that may be formed by, or otherwise associated with, the first serving cell (e.g., the first set of beams 310-a, the second set of beams 310-b). The codebook may also include codepoints, and a network entity may use the codepoints in a cross-serving cell scheme to identify the first set of beams 310-a, the first set of resources 305-a, the second set of beams 310-b, the second set of resources 305-b, or a combination thereof. The codebook may include codebook indices where each resource of a set of resources 305 or each beam of a set of beams 310 is indicated by a unique codebook index. In some examples, the network entity may use the codepoints to indicate that the first set of resources 305-a and the second set of resources 305-b are associated with each other, or that the first set of beams 310-a and the second set of beams 310-b are associated with each other, or both.

The network entity may indicate or request that the UE transmits a CSI report associated with the first serving cell to the network entity, and the UE may transmit the CSI report 315 to the network entity. The UE may include in the CSI report 315 measurements of the first set of resources 305-a associated with the first set of beams 310-a, predicted measurements for the second set of resources 305-b associated with the second set of beams 310-b, or a combination thereof. The UE may indicate via the CSI report an association between measurements of the first set of resources 305-a and predicted measurements of the second set of resources 305-b (e.g., according to codepoints in the indicated codebook). In some examples, the UE may indicate preferred beams, optimal beams, or candidate beams from the sets of beams 310 via the CSI report by selecting codepoint indices in the codebook that correspond to the preferred beams, optimal beams, or candidate beams. In other examples, the UE may indicate preferred or candidate resources from the sets of resources 305 by selecting codepoint indices from the codebook that correspond to the preferred or candidate resources. By using codepoint indices to select beams or resources in the CSI report, the UE may support low RRC overhead, or flexibility to dynamically alter beam point directions or beam widths, or both.

In some cases, the CSI report, the set of beams 310-a (and corresponding set of resources 305-a), and the set of beams 310-b (and corresponding set of resources 305-b) may be associated with a single serving cell. However, techniques described herein describe signaling and procedures for cross serving cell configurations of set A and set B beams (e.g., a first set of beams 310-a and a second set of beams 310-b in a second serving cell). A UE may be currently active in a first serving cell. The UE may perform CSI reporting in a currently active serving cell, but may indicate predicted channel quality information for a second serving cell (e.g., for set A and set B beams together with associations from other serving cells are configured or indicated by signaling associated with the CSI reports in the currently active serving cell).

In some examples, a network entity may request a UE from a first serving cell to transmit feedback information to the network entity via one or more CSI reports. The network entity may request that the feedback information includes measurement results of the set of resources 305-a (e.g., CMRs) and the set of resources 305-b (e.g., CRMs or virtual resources) defined within one or more second serving cells different from the first serving cell. The network entity may also request that the CSI report include predicted measurements (e.g., L1-RSRP, L1-SINR) of the set of resources 305-b (e.g., CMRs, virtual resources) defined within the one or more second serving cells different from the first serving cell. For example, the network entity may transmit control signaling to the UE indicating a cross serving cell scheme that identifies the first set of resources 305-a that are associated with the second set of resources 305-b (e.g., for a second serving cell). The first set of resources 305-a may be for measuring channel quality for the first set of beams 310-a and the second set of resources 305-b may be for predicting channel quality for the second set of beams 310-b.

The UE may perform the predicted measurements (e.g., L1-RSRP, L1-SINR) based on associations between the first set of resources 305-a and the second set of resources 305-b. For example, the UE may perform one or more channel measurements via the first set of resources using the first set of beams according to the cross serving cell scheme. Based on the one or more channel measurements, the UE may transmit to the network entity (e.g., to the first serving cell) the CSI report 315 indicating predicted channel quality information (e.g., predicted measurements) for the second set of resources 305-b for the second set of beams 310-b associated with the second serving cell.

Associations between the set of resources 305-a and the set of resources 305-b may be separately configured or indicated in the first serving cell, the one or more second serving cells, or a combination thereof. For example, control signaling that indicates cross serving cell scheme may identify an association between the set of resources 305-a and the set of resources 305-b. In some cases, a codebook may indicate beams formable by, or otherwise associated with, the second serving cell (e.g., the set of beams 310-a, the set of beams 310-b for the second cell). The network entity may configure the UE with the codebook of beams formable by the second serving cell (e.g., via RRC configuration within the configuration information of the second serving cell). The configuration may include the codebook, and the UE may identify associations between the first set of beams 310-a and the second set of beams 310-b of the second serving cell using beamforming codepoints within the codebook.

Thus, as described herein, the network entity may request (e.g., from the first serving cell) that the UE feedback to the network entity one or more CSI reports. The UE may indicate, based on measurement results on a first number or quantity of CMRs (e.g., the first set of resources 305-a) defined with reference to (e.g., within) one or more second serving cells, predicted channel quality measurements (e.g., predicted L1-RSRPs, L1-SINRs) regarding the second number or quantity of CMRs or virtual resources (e.g., the second set of resources 305-b) defined with reference to (e.g., within) the second serving cell. The predicted channel quality measurements may be based on an association between the first number or quantity of CMRs and the second number or quantity of CMRs or virtual resources, and the associations may be separately configured or indicated in the first serving cell, or the second serving cell.

FIGS. 4A and 4B illustrate examples of CSI reporting configurations 400 and 435 that support cross-serving cell predictive beam management in accordance with one or more aspects of the present disclosure. The CSI reporting configurations 400 and 435 may implement or may be implemented by aspects of the wireless communications systems 100 and 200. For example, CSI reporting configurations 400 and 435 may include CSI report information, such as a CSI report setting 405-a and a CSI report setting 405-b, which may be examples of a CSI report information message 215 as described with reference to FIG. 2. In some examples, the CSI report setting 405 may be an example of or may indicate a cross serving cell scheme that identifies a first set of resources of a second serving cell that are associated with a second set of resources of the second serving cell.

In some examples, to configure resources of the second serving cell, serving cell identifiers (IDs) of the second serving cell (e.g., and an indication of the first and second quantity of resources) may be configured by and indicated by CSI report setting messages (e.g., CSI report setting 405). The CSI report setting 405 may be provided by periodic, semi-persistent, aperiodic, or any other signaling that is communicated from the network entity 105-a to the UE 115-a. In some examples, the CSI report setting 405 may be provided by a MAC-CE message activating semi-persistent CSI reporting, or by a configuration information (e.g., a CSI-AssociatedReportConfigInfo) message with respect to an aperiodic CSI report.

In FIG. 4A, the resources (e.g., the resource set 410-a, which may indicate the first and second quantity of resources of the first and second sets of resources, as described in greater detail with reference to FIG. 3) may be identified based on the CMR sets or virtual resource sets defined in the second serving cell. For example, a network entity may transmit a CSI report message (e.g., the CSI report setting 405-a) to a UE within a first serving cell. The network entity may trigger (e.g., by providing the CSI report setting 405-a) a CSI report by the UE. The network entity may identify (e.g., in the CSI report setting 405-a) that a resource set 410-a (e.g., the first set of CMRs for CSI measurement and the second set of CMRs or virtual resources for CSI prediction) within the CSI report setting 405-a is defined with reference to a second serving cell different from the first serving cell. For example, the CSI report setting 405-a may indicate the resource set 410-a (e.g., including a first set of resources associated with a first set of beams and a second set of resources associated with a second set of beams) using a serving cell ID 415-a. That is, the network entity may indicate that all resources within the resource set 410-a are associated with (e.g., defined with reference to) the second serving cell having the serving cell ID 415-a. The resource set 410-a may include an indication of a first set of resources (e.g., set A) and a second set of resources (e.g., set B) associated with the second serving cell, as described with reference to FIGS. 2 and 3. In some examples, the CSI report setting 405-a may include the resource set 410-a (e.g., associated with the serving cell ID 415-a for the second serving cell) and an additional resource set 410 (e.g., associated with a serving cell ID for the first serving cell). In some examples, the network entity may transmit the CSI report setting 405-a in addition to a separate CSI report setting (e.g., default CSI report setting) that identifies a resource set including resources that are associated with the first serving cell.

The network entity may configure or indicate the serving cell ID 415-a via the CSI report setting information 420, which may be an example of the CSI report setting 405-a (e.g., the serving cell ID 415-a may be included in the CSI report setting itself) or may be included within the CSI report setting 405-a itself. In some examples, the network entity may configure or indicate the serving cell ID 415-a via a control message 425 (e.g., MAC-CE) that activates the CSI report at the UE (e.g., the CSI report setting 405-a may include or may be an example of a MAC-CE activating the CSI report, such as a semi-persistent CSI report). In some examples, the network entity may configure or indicate the serving cell ID 415-a via a configuration information 430 (e.g., CSI-AssociatedReportConfigInfo) that configures the CSI report at the UE or triggers the UE to transmit (e.g., aperiodically) the CSI report (e.g., the CSI report setting 405-a may include or be an example of configuration information 430 identified by the serving cell ID 415-a for the second serving cell).

In FIG. 4B, the first and second sets of resources may be further identified based on CMR sets or virtual resource sets defined in the first serving cell, where such resource sets further include serving cell IDs of the second serving cell together with such resources defined in the second serving cell (e.g., individual resources of the resource set in the second serving cell may be identified by a serving cell ID of the second serving cell). In some examples, a network entity may transmit the CSI report setting 405-b to a UE within a first serving cell which may configure a CSI report at the UE for the second serving cell. The network entity may include a resource set 410-b in the CSI report setting 405-b. The resource set 410-b may include resources associated with both the first serving cell and the second serving cell. In some examples, the network entity may indicate the CSI report setting 405-b with a serving cell ID of the first serving cell, and each resource of a first set of resources (e.g., first set of resources 305-a) and a second set of resources of the second serving cell within the resource set 410-b may correspond to the serving cell ID 415-b of the second serving cell. In some examples, the resource set 410-b may also include a first set of resources and a second set of resources of the first serving cell, which may correspond to the serving cell ID of the first serving cell or may not be identified as corresponding to a serving cell-specific ID.

The network entity may indicate one or more serving cell IDs 415 for individual resources 440 of the resource set 410-b. The serving cell IDs 415 may indicate which resources in the resource set 410-b correspond to the second serving cell. For example, resources 440-a may indicate a first set of resources (e.g., set A, such as the second set of resources 305-a) and a second set of resources (e.g., set B, such as the second set of resources 305-b) for the second serving cell, and the network entity may indicate that the resources 440-a are associated with the second serving cell via the serving cell ID 415-b (e.g., for each resource 440-a, or for sets of resources 440-a). The resources 440-b may be a second set of resources (e.g., including a set A and a set B) for the second serving cell, and the network entity may indicate that the resources 440-b are associated with the second serving cell via the serving cell ID 415-b.

In some examples, the network entity may indicate, via the CSI report setting 405, associations between a first set of beams (set A) and a second set of beams (set B) in the second serving cell. In some cases, the associations may be identified based on an RRC configuration at a UE in the second serving cell. The RRC configuration may configure each of the respective resources corresponding to the second serving cell, where the configuration includes at least one of a beam pointing direction or beam width information (e.g., for the first set of beams 310-a and the second set of beams 310-b associated with the first set of resources 305-a and the second set of resources 305-b in each serving cell). For example, the UE may receive, from the network entity (e.g., in the second serving cell), a control message including configuration information indicating each resource of the first set of resources and the second set of resources of the second serving cell, a beam direction for each of the first set of beams and the second set of beams of the second serving cell, or a combination thereof.

In some examples, the network entity may configure a serving cell-specific beamforming codebook. The network entity may configure (e.g., via RRC configuration in the second serving cell) a beamforming codebook for the second serving cell that includes a set of candidate resources, a set of candidate beam pointing directions, a set of candidate beam widths, or any combination thereof, that may be formed by, or otherwise associated with, the second serving cell. The resource set 410 (e.g., resource set 410-a, resource set 410-b) within the CSI report setting 405 may indicate one or more beamforming codepoints within the codebook of the second serving cell that correspond to one or more candidate beams or one or more CMRs. Additionally, or alternatively, the resources in the resource set 410 may be semi-persistently (SP) activated via MAC-CE (e.g., in the second serving cell), and the MAC-CE may indicate beamforming codepoints within the codebook of the second serving cell that correspond to candidate beams or CMRs. Thus, RRC signaling may indicate a codebook including various candidate sets of resources and beams (e.g., different numbers, quantities, or sets of resources in each of set A and set B, and different beams, beam directions, or beam widths for each of set A and set B), and the network may indicate, via one or more codepoints of the codebook (e.g., in the CSI report setting) the resource set 410 (e.g., the resource set 410-a).

In some cases, the associations between the first set of beams and the second set of beams of the second serving cell may be jointly configured or indicated in the first serving cell and the second serving cell. The network entity may preconfigure a beamforming codebook for the second serving cell via RRC configuration. In some examples, the network entity may indicate the resource set 410-b within the CSI report setting 405-b. For example, the network entity may indicate one or more beamforming codepoints within a configured codebook for the first serving cell for resources 440 within the resource set 410-b that correspond to the first serving cell. Additionally, the network entity may indicate one or more beamforming codepoints within the configured codebook for the second serving cell for resources 440 within the resource set 410-b that correspond the second serving cell.

In some examples, a control message (e.g., MAC-CE, control message 425) activating the CSI report (e.g., a semi-persistent CSI report) at the UE or a configuration information 430 associated with the CSI report (e.g., an aperiodic CSI report) may indicate or configure one or more beamforming codepoints for each of the resources associated with the CSI report (e.g., resources 440 within resource set 410-b). The one or more codepoints in the codebook configured at the second serving cell may indicate that the resources 440 are associated with the CSI report of the first serving cell, or that the resources 440 are associated with corresponding resources in the first serving cell.

FIG. 5 illustrates an example of a process flow 500 that supports cross-serving cell predictive beam management in accordance with one or more aspects of the present disclosure. The process flow 500 may implement or may be implemented by aspects of the wireless communications systems 100 and 200. For example, the process flow 500 may include a UE 115-b, a first serving cell 501-a (e.g., a serving cell 205-a) a second serving cell 501-b (e.g., a serving cell 205 such as a serving cell 205-b). Each serving cell 501 may be associated with at least one network entity 105 (e.g., a single network entity 105 may operate via each serving cell 501, or each serving cell 501 may correspond to a respective network entity 105. The UE 115-b, the serving cells 501, and the network entity, may be examples of corresponding devices and entities as described with reference to FIGS. 1-4B. In the following description of the process flow 500, the operations between the UE 115-b and the serving cells 501 may be transmitted in a different order than the example order shown, or the operations performed by the UE 115-b and the serving cells 501 may be performed in different orders or at different times. Some operations may also be omitted from the process flow 500, and other operations may be added to the process flow 500.

At 505, the UE 115-b may transmit capability information indicating that the UE 115-b supports beam prediction based on a cross serving cell scheme. In some examples, the capability information may be reported to the first serving cell 501-a separate from capability information indicating that the UE 115-b supports beam prediction for a single active cell (e.g., the first serving cell 501-a). The capability information may include a quantity of additional (e.g., second) serving cells (e.g., second serving cell 205-b) for which the UE may support beam prediction.

In some cases, the capability information may include a threshold prediction accuracy for beam prediction for one or more additional serving cells. The threshold prediction accuracy may be specific to each additional serving cell, and in some examples, may be based on a distance from the first serving cell 501-a to the second serving cell 501-b (e.g., prediction accuracy may be a function of the UE 115-b being within a defined distance of a serving cell). In some examples, the capability information may include a quantity of reference signal resources, or a type of reference signal resources, or both, that may be used as measurement resources, or that may be used as prediction targets, for each of the additional serving cells. The UE 115-b may report the capability information to the first serving cell 501-a via RRC configuration during initial access, via dynamic updates after initial access, or both. The UE 115-b may expect to be configured by a network entity, with beam prediction requests meeting its reported capabilities. In some examples, the UE 115-b may report its capability information through RRC signaling during initial access, and optionally also through dynamic updates after initial access.

At 510, the UE 115-b may receive, via a first serving cell 501-a (e.g., from a network entity), control signaling (e.g., a CSI report information message) indicating a cross serving cell scheme that identifies a first set of resources of the second serving cell 501-b that are associated with a second set of resources. The first set of resources may be for measuring channel quality for a first set of beams (e.g., set A) and the second set of resources may be for predicting channel quality for a second set of beams (e.g., set B). The UE 115-b may receive the control signaling based on capability information of the UE 115-b (e.g., as indicated at 505).

The UE 115-b may also receive CSI reporting information including an indication of an identifier of the second serving cell 501-b (e.g., serving cell ID 415 as described with reference to FIGS. 4A and 4B). The CSI reporting information may include an indication of the first set of resources and the second set of resources (e.g., within the resource set 410-a as described with reference to FIG. 4A) defined with reference to (e.g., labeled with, indicated with) the identifier of the second serving cell 501-b. The UE 115-b may receive the CSI reporting information via a CSI report setting message, a MAC-CE activating the CSI report, a CSI configuration message triggering the CSI report, or any combination thereof.

In some cases, the UE 115-b may receive the CSI reporting information including an indication of an identifier of the first serving cell 501-a and a plurality of resources (e.g., the resource set 410-b as described with reference to FIG. 4B) comprising the first set of resources and the second set of resources (e.g., of the second serving cell 501-b). Each resource of the first set of resources and the second set of resources may correspond to an identifier of the second serving cell 501-b.

At 515, the UE 115-b may receive, via the second serving cell 501-b, a control message including configuration information indicating each resource of the first set of resources and the second set of resources, a beam direction for each of the first set of beams and the second set of beams, or a combination thereof. The UE 115-b may receive, via the configuration information (e.g., via RRC configuration at the second serving cell 501-b), an indication of a codebook (e.g., serving cell-specific codebook) comprising a set of candidate resources, a set of candidate beam directions, a set of candidate beam widths, or any combination thereof.

At 520, the UE 115-b may perform one or more channel measurements via the first set of resources using the first set of beams according to the cross serving cell scheme. At 525, the UE 115-b may transmit, to the first serving cell 501-a based on the one or more channel measurements and the cross serving cell scheme, a CSI report indicating predicted channel quality information for the second set of resources for the second set of beams associated with the second serving cell 501-b.

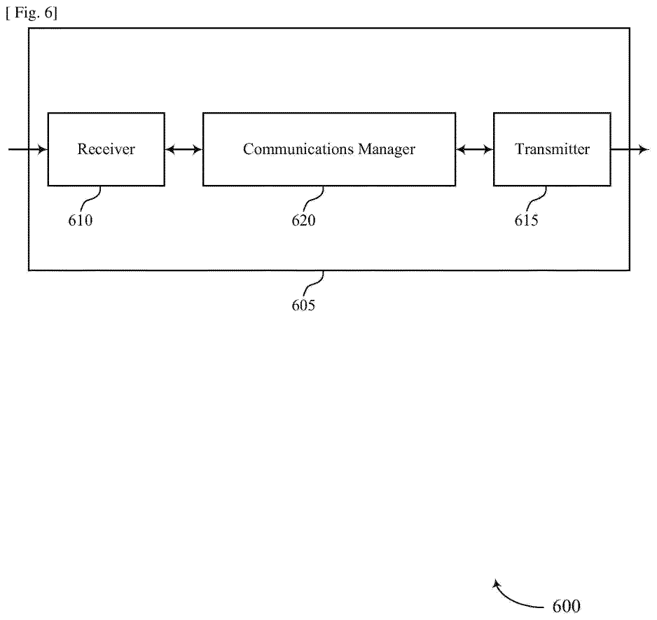

FIG. 6 illustrates a block diagram 600 of a device 605 that supports cross-serving cell predictive beam management in accordance with one or more aspects of the present disclosure. The device 605 may be an example of aspects of a UE 115 as described herein. The device 605 may include a receiver 610, a transmitter 615, and a communications manager 620. The device 605 may also include a processor. Each of these components may be in communication with one another (e.g., via one or more buses).

The receiver 610 may provide a means for receiving information such as packets, user data, control information, or any combination thereof associated with various information channels (e.g., control channels, data channels, information channels related to cross-serving cell predictive beam management). Information may be passed on to other components of the device 605. The receiver 610 may utilize a single antenna or a set of multiple antennas.

The transmitter 615 may provide a means for transmitting signals generated by other components of the device 605. For example, the transmitter 615 may transmit information such as packets, user data, control information, or any combination thereof associated with various information channels (e.g., control channels, data channels, information channels related to cross-serving cell predictive beam management). In some examples, the transmitter 615 may be co-located with a receiver 610 in a transceiver module. The transmitter 615 may utilize a single antenna or a set of multiple antennas.

The communications manager 620, the receiver 610, the transmitter 615, or various combinations thereof or various components thereof may be examples of means for performing various aspects of cross-serving cell predictive beam management as described herein. For example, the communications manager 620, the receiver 610, the transmitter 615, or various combinations or components thereof may support a method for performing one or more of the functions described herein.

In some examples, the communications manager 620, the receiver 610, the transmitter 615, or various combinations or components thereof may be implemented in hardware (e.g., in communications management circuitry). The hardware may include a processor, a digital signal processor (DSP), a central processing unit (CPU), a graphics processing unit (GPU), an application-specific integrated circuit (ASIC), a field-programmable gate array (FPGA) or other programmable logic device, a microcontroller, discrete gate or transistor logic, discrete hardware components, or any combination thereof configured as or otherwise supporting a means for performing the functions described in the present disclosure. In some examples, a processor and memory coupled with the processor may be configured to perform one or more of the functions described herein (e.g., by executing, by the processor, instructions stored in the memory).

Additionally, or alternatively, in some examples, the communications manager 620, the receiver 610, the transmitter 615, or various combinations or components thereof may be implemented in code (e.g., as communications management software) executed by a processor. If implemented in code executed by a processor, the functions of the communications manager 620, the receiver 610, the transmitter 615, or various combinations or components thereof may be performed by a general-purpose processor, a DSP, a CPU, a GPU, an ASIC, an FPGA, a microcontroller, or any combination of these or other programmable logic devices (e.g., configured as or otherwise supporting a means for performing the functions described in the present disclosure).

In some examples, the communications manager 620 may be configured to perform various operations (e.g., receiving, obtaining, monitoring, outputting, transmitting) using or otherwise in cooperation with the receiver 610, the transmitter 615, or both. For example, the communications manager 620 may receive information from the receiver 610, send information to the transmitter 615, or be integrated in combination with the receiver 610, the transmitter 615, or both to obtain information, output information, or perform various other operations as described herein.

The communications manager 620 may support wireless communications at a UE in accordance with examples as disclosed herein. For example, the communications manager 620 may be configured as or otherwise support a means for receiving, from a first serving cell, control signaling indicating a cross serving cell scheme that identifies a first set of resources of a second serving cell that are associated with a second set of resources of the second serving cell, the first set of resources for measuring channel quality for a first set of beams and the second set of resources for predicting channel quality for a second set of beams. The communications manager 620 may be configured as or otherwise support a means for performing one or more channel measurements via the first set of resources using the first set of beams according to the cross serving cell scheme. The communications manager 620 may be configured as or otherwise support a means for transmitting, to the first serving cell based on the one or more channel measurements and the cross serving cell scheme, a CSI report indicating predicted channel quality information for the second set of resources for the second set of beams associated with the second serving cell.

By including or configuring the communications manager 620 in accordance with examples as described herein, the device 605 (e.g., a processor controlling or otherwise coupled with the receiver 610, the transmitter 615, the communications manager 620, or a combination thereof) may support techniques for reduced processing associated with a UE switching from a first serving cell to a second serving cell. For example, the UE may refrain from performing one or more new or redundant channel quality measurements based on switching to the second serving cell by utilizing channel quality measurements for the second serving cell that were previously performed in a serving cell (e.g., the first serving cell) different from the second serving cell.

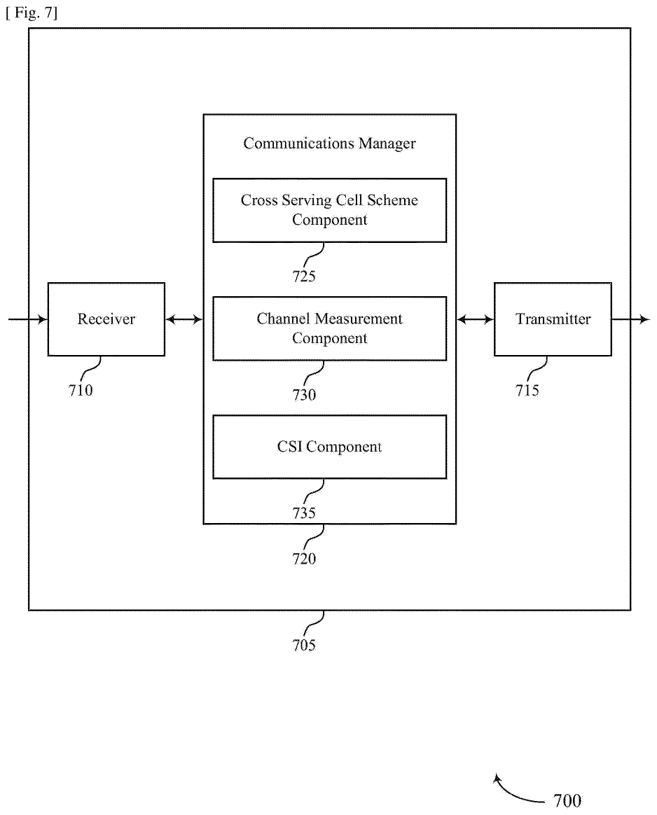

FIG. 7 illustrates a block diagram 700 of a device 705 that supports cross-serving cell predictive beam management in accordance with one or more aspects of the present disclosure. The device 705 may be an example of aspects of a device 605 or a UE 115 as described herein. The device 705 may include a receiver 710, a transmitter 715, and a communications manager 720. The device 705 may also include a processor. Each of these components may be in communication with one another (e.g., via one or more buses).

The receiver 710 may provide a means for receiving information such as packets, user data, control information, or any combination thereof associated with various information channels (e.g., control channels, data channels, information channels related to cross-serving cell predictive beam management). Information may be passed on to other components of the device 705. The receiver 710 may utilize a single antenna or a set of multiple antennas.

The transmitter 715 may provide a means for transmitting signals generated by other components of the device 705. For example, the transmitter 715 may transmit information such as packets, user data, control information, or any combination thereof associated with various information channels (e.g., control channels, data channels, information channels related to cross-serving cell predictive beam management). In some examples, the transmitter 715 may be co-located with a receiver 710 in a transceiver module. The transmitter 715 may utilize a single antenna or a set of multiple antennas.

The device 705, or various components thereof, may be an example of means for performing various aspects of cross-serving cell predictive beam management as described herein. For example, the communications manager 720 may include a cross serving cell scheme component 725, a channel measurement component 730, a CSI component 735, or any combination thereof. The communications manager 720 may be an example of aspects of a communications manager 620 as described herein. In some examples, the communications manager 720, or various components thereof, may be configured to perform various operations (e.g., receiving, obtaining, monitoring, outputting, transmitting) using or otherwise in cooperation with the receiver 710, the transmitter 715, or both. For example, the communications manager 720 may receive information from the receiver 710, send information to the transmitter 715, or be integrated in combination with the receiver 710, the transmitter 715, or both to obtain information, output information, or perform various other operations as described herein.

The communications manager 720 may support wireless communications at a UE in accordance with examples as disclosed herein. The cross serving cell scheme component 725 may be configured as or otherwise support a means for receiving, from a first serving cell, control signaling indicating a cross serving cell scheme that identifies a first set of resources of a second serving cell that are associated with a second set of resources of the second serving cell, the first set of resources for measuring channel quality for a first set of beams and the second set of resources for predicting channel quality for a second set of beams. The channel measurement component 730 may be configured as or otherwise support a means for performing one or more channel measurements via the first set of resources using the first set of beams according to the cross serving cell scheme. The CSI component 735 may be configured as or otherwise support a means for transmitting, to the first serving cell based on the one or more channel measurements and the cross serving cell scheme, a CSI report indicating predicted channel quality information for the second set of resources for the second set of beams associated with the second serving cell.

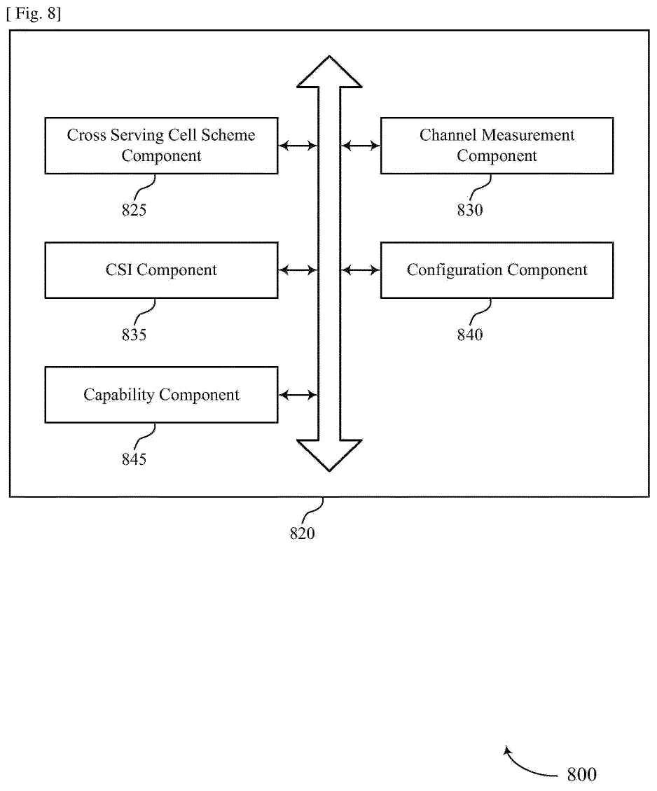

FIG. 8 illustrates a block diagram 800 of a communications manager 820 that supports cross-serving cell predictive beam management in accordance with one or more aspects of the present disclosure. The communications manager 820 may be an example of aspects of a communications manager 620, a communications manager 720, or both, as described herein. The communications manager 820, or various components thereof, may be an example of means for performing various aspects of cross-serving cell predictive beam management as described herein. For example, the communications manager 820 may include a cross serving cell scheme component 825, a channel measurement component 830, a CSI component 835, a configuration component 840, a capability component 845, or any combination thereof. Each of these components may communicate, directly or indirectly, with one another (e.g., via one or more buses).

The communications manager 820 may support wireless communications at a UE in accordance with examples as disclosed herein. The cross serving cell scheme component 825 may be configured as or otherwise support a means for receiving, from a first serving cell, control signaling indicating a cross serving cell scheme that identifies a first set of resources of a second serving cell that are associated with a second set of resources of the second serving cell, the first set of resources for measuring channel quality for a first set of beams and the second set of resources for predicting channel quality for a second set of beams. The channel measurement component 830 may be configured as or otherwise support a means for performing one or more channel measurements via the first set of resources using the first set of beams according to the cross serving cell scheme. The CSI component 835 may be configured as or otherwise support a means for transmitting, to the first serving cell based on the one or more channel measurements and the cross serving cell scheme, a CSI report indicating predicted channel quality information for the second set of resources for the second set of beams associated with the second serving cell.

In some examples, to support receiving the control signaling, the cross serving cell scheme component 825 may be configured as or otherwise support a means for receiving CSI reporting information including an indication of an identifier of the second serving cell, where the CSI reporting information includes an indication of the first set of resources and the second set of resources defined with reference to the identifier of the second serving cell.

In some examples, to support receiving the CSI reporting information, the cross serving cell scheme component 825 may be configured as or otherwise support a means for receiving a CSI report setting message, a MAC control element (CE) activating the CSI report, a CSI configuration message triggering the CSI report, or any combination thereof.

In some examples, to support receiving the control signaling, the cross serving cell scheme component 825 may be configured as or otherwise support a means for receiving CSI reporting information including an indication of an identifier of the first serving cell and a set of multiple resources including the first set of resources and the second set of resources, where each resource of the first set of resources and the second set of resources corresponds to an identifier of the second serving cell.

In some examples, the configuration component 840 may be configured as or otherwise support a means for receiving, from the second serving cell, a control message including configuration information indicating each resource of the first set of resources and the second set of resources, a beam direction for each of the first set of beams and the second set of beams, or a combination thereof, where the cross serving cell scheme identifies the first set of resources, the first set of beams, the second set of resources, the second set of beams, or any combination thereof, based on the configuration information.

In some examples, the configuration component 840 may be configured as or otherwise support a means for receiving, via the configuration information, an indication of a codebook including a set of candidate resources, a set of candidate beam directions, a set of candidate beam widths, or any combination thereof, where the cross serving cell scheme includes a codepoint of the codebook indicating the first set of resources, the first set of beams, the second set of resources, the second set of beams, or any combination thereof.

In some examples, the capability component 845 may be configured as or otherwise support a means for transmitting capability information indicating that the UE supports beam prediction based on the cross serving cell scheme, where receiving the control signaling indicating the cross serving cell scheme is based on the capability information.

In some examples, the capability component 845 may be configured as or otherwise support a means for transmitting, via the capability information, an indication that the UE supports beam prediction for the second serving cell via the first serving cell.

In some examples, the capability component 845 may be configured as or otherwise support a means for transmitting, via the capability information, a quantity of serving cells for which the UE supports the cross serving cell scheme, the quantity of serving cells including the second serving cell.

In some examples, the capability component 845 may be configured as or otherwise support a means for transmitting, via the capability information, an indication of a threshold prediction accuracy for the second serving cell.

In some examples, the threshold prediction accuracy is based on a location of the UE.

In some examples, the capability component 845 may be configured as or otherwise support a means for transmitting, via the capability information, an indication of a quantity of beams in the second set of beams, a type of beams for the second set of beams, or a combination thereof, based on the threshold prediction accuracy.

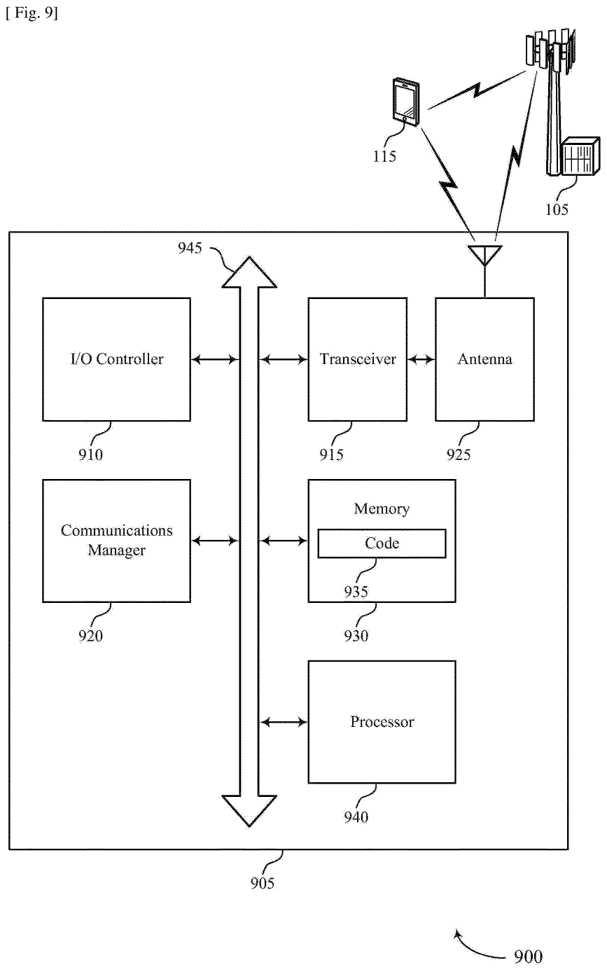

FIG. 9 illustrates a diagram of a system 900 including a device 905 that supports cross-serving cell predictive beam management in accordance with one or more aspects of the present disclosure. The device 905 may be an example of or include the components of a device 605, a device 705, or a UE 115 as described herein. The device 905 may communicate (e.g., wirelessly) with one or more network entities 105, one or more UEs 115, or any combination thereof. The device 905 may include components for bi-directional voice and data communications including components for transmitting and receiving communications, such as a communications manager 920, an input/output (I/O) controller 910, a transceiver 915, an antenna 925, a memory 930, code 935, and a processor 940. These components may be in electronic communication or otherwise coupled (e.g., operatively, communicatively, functionally, electronically, electrically) via one or more buses (e.g., a bus 945).

The I/O controller 910 may manage input and output signals for the device 905. The I/O controller 910 may also manage peripherals not integrated into the device 905. In some cases, the I/O controller 910 may represent a physical connection or port to an external peripheral. In some cases, the I/O controller 910 may utilize an operating system such as iOS®, ANDROID®, MS-DOS®, MS-WINDOWS®, OS/2®, UNIX®, LINUX®, or another known operating system. Additionally, or alternatively, the I/O controller 910 may represent or interact with a modem, a keyboard, a mouse, a touchscreen, or a similar device. In some cases, the I/O controller 910 may be implemented as part of a processor, such as the processor 940. In some cases, a user may interact with the device 905 via the I/O controller 910 or via hardware components controlled by the I/O controller 910.

In some cases, the device 905 may include a single antenna 925. However, in some other cases, the device 905 may have more than one antenna 925, which may be capable of concurrently transmitting or receiving multiple wireless transmissions. The transceiver 915 may communicate bi-directionally, via the one or more antennas 925, wired, or wireless links as described herein. For example, the transceiver 915 may represent a wireless transceiver and may communicate bi-directionally with another wireless transceiver. The transceiver 915 may also include a modem to modulate the packets, to provide the modulated packets to one or more antennas 925 for transmission, and to demodulate packets received from the one or more antennas 925. The transceiver 915, or the transceiver 915 and one or more antennas 925, may be an example of a transmitter 615, a transmitter 715, a receiver 610, a receiver 710, or any combination thereof or component thereof, as described herein.

The memory 930 may include random access memory (RAM) and read-only memory (ROM). The memory 930 may store computer-readable, computer-executable code 935 including instructions that, when executed by the processor 940, cause the device 905 to perform various functions described herein. The code 935 may be stored in a non-transitory computer-readable medium such as system memory or another type of memory. In some cases, the code 935 may not be directly executable by the processor 940 but may cause a computer (e.g., when compiled and executed) to perform functions described herein. In some cases, the memory 930 may contain, among other things, a basic I/O system (BIOS) which may control basic hardware or software operation such as the interaction with peripheral components or devices.

The processor 940 may include an intelligent hardware device (e.g., a general-purpose processor, a DSP, a CPU, a microcontroller, a GPU, an ASIC, an FPGA, a programmable logic device, a discrete gate or transistor logic component, a discrete hardware component, or any combination thereof). In some cases, the processor 940 may be configured to operate a memory array using a memory controller. In some other cases, a memory controller may be integrated into the processor 940. The processor 940 may be configured to execute computer-readable instructions stored in a memory (e.g., the memory 930) to cause the device 905 to perform various functions (e.g., functions or tasks supporting cross-serving cell predictive beam management). For example, the device 905 or a component of the device 905 may include a processor 940 and memory 930 coupled with or to the processor 940, the processor 940 and memory 930 configured to perform various functions described herein.

The communications manager 920 may support wireless communications at a UE in accordance with examples as disclosed herein. For example, the communications manager 920 may be configured as or otherwise support a means for receiving, from a first serving cell, control signaling indicating a cross serving cell scheme that identifies a first set of resources of a second serving cell that are associated with a second set of resources of the second serving cell, the first set of resources for measuring channel quality for a first set of beams and the second set of resources for predicting channel quality for a second set of beams. The communications manager 920 may be configured as or otherwise support a means for performing one or more channel measurements via the first set of resources using the first set of beams according to the cross serving cell scheme. The communications manager 920 may be configured as or otherwise support a means for transmitting, to the first serving cell based on the one or more channel measurements and the cross serving cell scheme, a CSI report indicating predicted channel quality information for the second set of resources for the second set of beams associated with the second serving cell.

By including or configuring the communications manager 920 in accordance with examples as described herein, the device 905 may support techniques for reduced latency by reducing a duration of time that the UE performs channel quality measurements based on switching from a first serving cell to a second serving cell. For example, the UE may perform fewer channel quality measurements in the second serving cell by utilizing channel quality measurements previously performed in other serving cells, which may reduce latency for users of the UE, for example, in cases where the UE is mobile.

In some examples, the communications manager 920 may be configured to perform various operations (e.g., receiving, monitoring, transmitting) using or otherwise in cooperation with the transceiver 915, the one or more antennas 925, or any combination thereof. Although the communications manager 920 is illustrated as a separate component, in some examples, one or more functions described with reference to the communications manager 920 may be supported by or performed by the processor 940, the memory 930, the code 935, or any combination thereof. For example, the code 935 may include instructions executable by the processor 940 to cause the device 905 to perform various aspects of cross-serving cell predictive beam management as described herein, or the processor 940 and the memory 930 may be otherwise configured to perform or support such operations.

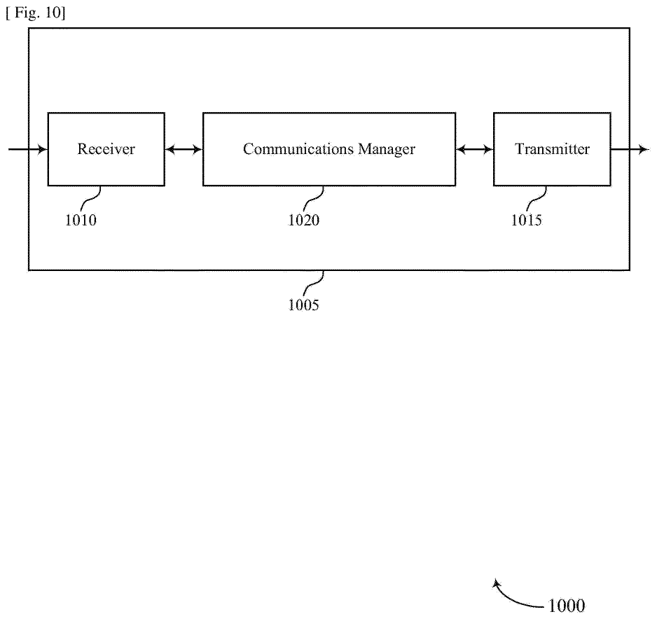

FIG. 10 illustrates a block diagram 1000 of a device 1005 that supports cross-serving cell predictive beam management in accordance with one or more aspects of the present disclosure. The device 1005 may be an example of aspects of a network entity 105 as described herein. The device 1005 may include a receiver 1010, a transmitter 1015, and a communications manager 1020. The device 1005 may also include a processor. Each of these components may be in communication with one another (e.g., via one or more buses).

The receiver 1010 may provide a means for obtaining (e.g., receiving, determining, identifying) information such as user data, control information, or any combination thereof (e.g., I/Q samples, symbols, packets, protocol data units, service data units) associated with various channels (e.g., control channels, data channels, information channels, channels associated with a protocol stack). Information may be passed on to other components of the device 1005. In some examples, the receiver 1010 may support obtaining information by receiving signals via one or more antennas. Additionally, or alternatively, the receiver 1010 may support obtaining information by receiving signals via one or more wired (e.g., electrical, fiber optic) interfaces, wireless interfaces, or any combination thereof.

The transmitter 1015 may provide a means for outputting (e.g., transmitting, providing, conveying, sending) information generated by other components of the device 1005. For example, the transmitter 1015 may output information such as user data, control information, or any combination thereof (e.g., I/Q samples, symbols, packets, protocol data units, service data units) associated with various channels (e.g., control channels, data channels, information channels, channels associated with a protocol stack). In some examples, the transmitter 1015 may support outputting information by transmitting signals via one or more antennas. Additionally, or alternatively, the transmitter 1015 may support outputting information by transmitting signals via one or more wired (e.g., electrical, fiber optic) interfaces, wireless interfaces, or any combination thereof. In some examples, the transmitter 1015 and the receiver 1010 may be co-located in a transceiver, which may include or be coupled with a modem.

The communications manager 1020, the receiver 1010, the transmitter 1015, or various combinations thereof or various components thereof may be examples of means for performing various aspects of cross-serving cell predictive beam management as described herein. For example, the communications manager 1020, the receiver 1010, the transmitter 1015, or various combinations or components thereof may support a method for performing one or more of the functions described herein.

In some examples, the communications manager 1020, the receiver 1010, the transmitter 1015, or various combinations or components thereof may be implemented in hardware (e.g., in communications management circuitry). The hardware may include a processor, a DSP, a CPU, a GPU, an ASIC, an FPGA or other programmable logic device, a microcontroller, discrete gate or transistor logic, discrete hardware components, or any combination thereof configured as or otherwise supporting a means for performing the functions described in the present disclosure. In some examples, a processor and memory coupled with the processor may be configured to perform one or more of the functions described herein (e.g., by executing, by the processor, instructions stored in the memory).

Additionally, or alternatively, in some examples, the communications manager 1020, the receiver 1010, the transmitter 1015, or various combinations or components thereof may be implemented in code (e.g., as communications management software) executed by a processor. If implemented in code executed by a processor, the functions of the communications manager 1020, the receiver 1010, the transmitter 1015, or various combinations or components thereof may be performed by a general-purpose processor, a DSP, a CPU, a GPU, an ASIC, an FPGA, a microcontroller, or any combination of these or other programmable logic devices (e.g., configured as or otherwise supporting a means for performing the functions described in the present disclosure).

In some examples, the communications manager 1020 may be configured to perform various operations (e.g., receiving, obtaining, monitoring, outputting, transmitting) using or otherwise in cooperation with the receiver 1010, the transmitter 1015, or both. For example, the communications manager 1020 may receive information from the receiver 1010, send information to the transmitter 1015, or be integrated in combination with the receiver 1010, the transmitter 1015, or both to obtain information, output information, or perform various other operations as described herein.

The communications manager 1020 may support wireless communications at a network entity in accordance with examples as disclosed herein. For example, the communications manager 1020 may be configured as or otherwise support a means for transmitting, via a first serving cell to a UE, control signaling indicating a cross serving cell scheme that identifies a first set of resources of a second serving cell that are associated with a second set of resources of the second serving cell, the first set of resources for measuring channel quality for a first set of beams and the second set of resources for predicting channel quality for a second set of beams. The communications manager 1020 may be configured as or otherwise support a means for receiving, from the UE via the first serving cell, based on the cross serving cell scheme, a CSI report indicating predicted channel quality information for the second set of resources for the second set of beams associated with the second serving cell.

By including or configuring the communications manager 1020 in accordance with examples as described herein, the device 1005 (e.g., a processor controlling or otherwise coupled with the receiver 1010, the transmitter 1015, the communications manager 1020, or a combination thereof) may support techniques for reduced processing associated with a UE switching from a first serving cell to a second serving cell. For example, the UE may refrain from performing one or more new or redundant channel quality measurements based on switching to the second serving cell by utilizing channel quality measurements for the second serving cell that were previously performed in a serving cell (e.g., the first serving cell) different from the second serving cell.

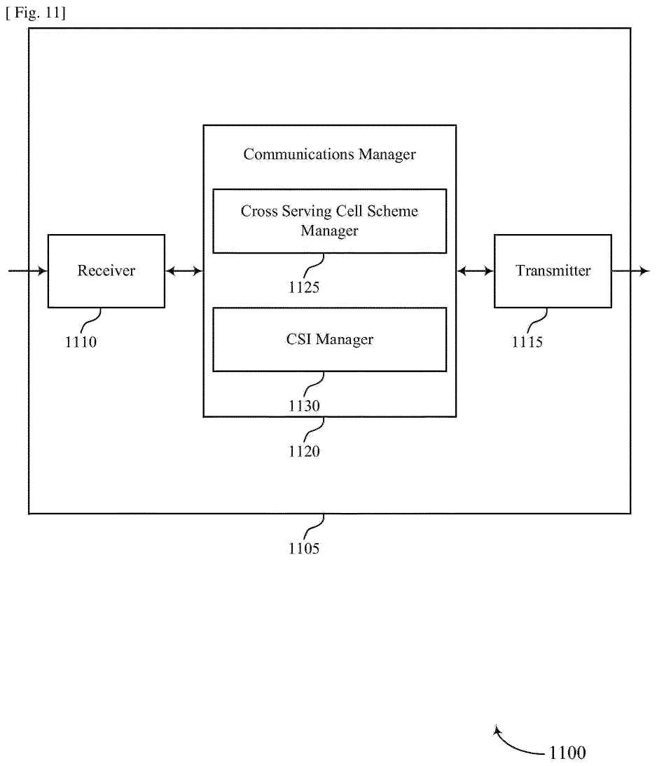

FIG. 11 illustrates a block diagram 1100 of a device 1105 that supports cross-serving cell predictive beam management in accordance with one or more aspects of the present disclosure. The device 1105 may be an example of aspects of a device 1005 or a network entity 105 as described herein. The device 1105 may include a receiver 1110, a transmitter 1115, and a communications manager 1120. The device 1105 may also include a processor. Each of these components may be in communication with one another (e.g., via one or more buses).

The receiver 1110 may provide a means for obtaining (e.g., receiving, determining, identifying) information such as user data, control information, or any combination thereof (e.g., I/Q samples, symbols, packets, protocol data units, service data units) associated with various channels (e.g., control channels, data channels, information channels, channels associated with a protocol stack). Information may be passed on to other components of the device 1105. In some examples, the receiver 1110 may support obtaining information by receiving signals via one or more antennas. Additionally, or alternatively, the receiver 1110 may support obtaining information by receiving signals via one or more wired (e.g., electrical, fiber optic) interfaces, wireless interfaces, or any combination thereof.

The transmitter 1115 may provide a means for outputting (e.g., transmitting, providing, conveying, sending) information generated by other components of the device 1105. For example, the transmitter 1115 may output information such as user data, control information, or any combination thereof (e.g., I/Q samples, symbols, packets, protocol data units, service data units) associated with various channels (e.g., control channels, data channels, information channels, channels associated with a protocol stack). In some examples, the transmitter 1115 may support outputting information by transmitting signals via one or more antennas. Additionally, or alternatively, the transmitter 1115 may support outputting information by transmitting signals via one or more wired (e.g., electrical, fiber optic) interfaces, wireless interfaces, or any combination thereof. In some examples, the transmitter 1115 and the receiver 1110 may be co-located in a transceiver, which may include or be coupled with a modem.

The device 1105, or various components thereof, may be an example of means for performing various aspects of cross-serving cell predictive beam management as described herein. For example, the communications manager 1120 may include a cross serving cell scheme manager 1125 a channel measurement manager 1130, or any combination thereof. The communications manager 1120 may be an example of aspects of a communications manager 1020 as described herein. In some examples, the communications manager 1120, or various components thereof, may be configured to perform various operations (e.g., receiving, obtaining, monitoring, outputting, transmitting) using or otherwise in cooperation with the receiver 1110, the transmitter 1115, or both. For example, the communications manager 1120 may receive information from the receiver 1110, send information to the transmitter 1115, or be integrated in combination with the receiver 1110, the transmitter 1115, or both to obtain information, output information, or perform various other operations as described herein.

The communications manager 1120 may support wireless communications at a network entity in accordance with examples as disclosed herein. The cross serving cell scheme manager 1125 may be configured as or otherwise support a means for transmitting, via a first serving cell to a UE, control signaling indicating a cross serving cell scheme that identifies a first set of resources of a second serving cell that are associated with a second set of resources of the second serving cell, the first set of resources for measuring channel quality for a first set of beams and the second set of resources for predicting channel quality for a second set of beams. The channel measurement manager 1130 may be configured as or otherwise support a means for receiving, from the UE via the first serving cell, based on the cross serving cell scheme, a CSI report indicating predicted channel quality information for the second set of resources for the second set of beams associated with the second serving cell.

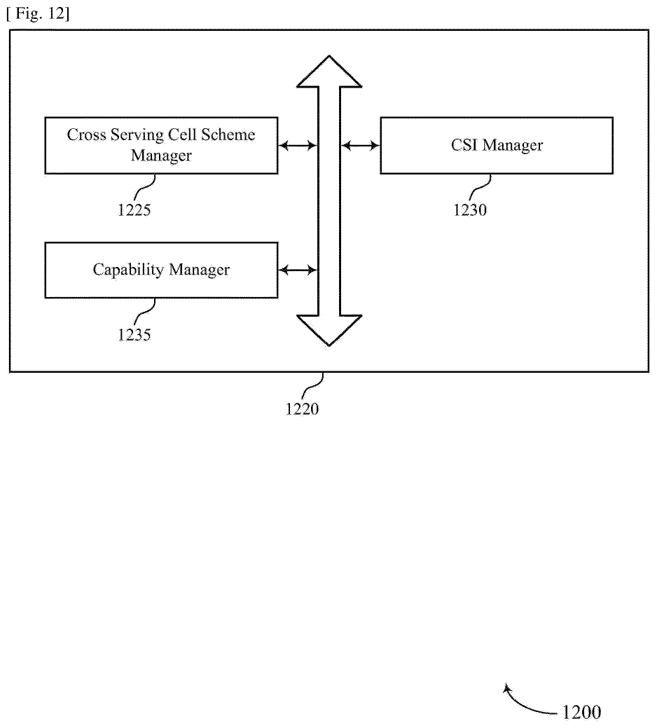

FIG. 12 illustrates a block diagram 1200 of a communications manager 1220 that supports cross-serving cell predictive beam management in accordance with one or more aspects of the present disclosure. The communications manager 1220 may be an example of aspects of a communications manager 1020, a communications manager 1120, or both, as described herein. The communications manager 1220, or various components thereof, may be an example of means for performing various aspects of cross-serving cell predictive beam management as described herein. For example, the communications manager 1220 may include a cross serving cell scheme manager 1225, a channel measurement manager 1230, a capability manager 1235, or any combination thereof. Each of these components may communicate, directly or indirectly, with one another (e.g., via one or more buses) which may include communications within a protocol layer of a protocol stack, communications associated with a logical channel of a protocol stack (e.g., between protocol layers of a protocol stack, within a device, component, or virtualized component associated with a network entity 105, between devices, components, or virtualized components associated with a network entity 105), or any combination thereof.

The communications manager 1220 may support wireless communications at a network entity in accordance with examples as disclosed herein. The cross serving cell scheme manager 1225 may be configured as or otherwise support a means for transmitting, via a first serving cell to a UE, control signaling indicating a cross serving cell scheme that identifies a first set of resources of a second serving cell that are associated with a second set of resources of the second serving cell, the first set of resources for measuring channel quality for a first set of beams and the second set of resources for predicting channel quality for a second set of beams. The channel measurement manager 1230 may be configured as or otherwise support a means for receiving, from the UE via the first serving cell, based on the cross serving cell scheme, a CSI report indicating predicted channel quality information for the second set of resources for the second set of beams associated with the second serving cell.

In some examples, to support transmitting the control signaling, the cross serving cell scheme manager 1225 may be configured as or otherwise support a means for transmitting CSI reporting information including an indication of an identifier of the second serving cell, where the CSI reporting information includes an indication of the first set of resources and the second set of resources defined with reference to the identifier of the second serving cell.

In some examples, to support transmitting the control signaling, the cross serving cell scheme manager 1225 may be configured as or otherwise support a means for transmitting a CSI report setting message, a MAC control element (CE) activating the CSI report, a CSI configuration message triggering the CSI report, or any combination thereof.

In some examples, to support transmitting the control signaling, the cross serving cell scheme manager 1225 may be configured as or otherwise support a means for CSI reporting information including an indication of an identifier of the first serving cell and a set of multiple resources including the first set of resources and the second set of resources, where each resource of the first set of resources and the second set of resources corresponds to an identifier of the second serving cell.

In some examples, the cross serving cell scheme identifies the first set of resources, the first set of beams, the second set of resources, the second set of beams, or any combination thereof, based on configuration information from the second serving cell indicating each resource of the first set of resources and the second set of resources, a beam direction for each of the first set of beams and the second set of beams, or a combination thereof.

In some examples, the configuration information includes an indication of a codebook including a set of candidate resources, a set of candidate beam directions, a set of candidate beam widths, or any combination thereof. In some examples, the cross serving cell scheme includes a codepoint of the codebook indicating the first set of resources, the first set of beams, the second set of resources, the second set of beams, or any combination thereof.

In some examples, the capability manager 1235 may be configured as or otherwise support a means for receiving capability information indicating that the UE supports beam prediction based on the cross serving cell scheme, where transmitting the control signaling indicating the cross serving cell scheme is based on the capability information.

In some examples, the capability manager 1235 may be configured as or otherwise support a means for receiving, via the capability information, a quantity of serving cells for which the UE supports the cross serving cell scheme, the quantity of serving cells including the second serving cell.

In some examples, the capability manager 1235 may be configured as or otherwise support a means for receiving, via the capability information, an indication of a threshold prediction accuracy for the second serving cell.

In some examples, the threshold prediction accuracy is based on a location of the UE.

In some examples, the capability manager 1235 may be configured as or otherwise support a means for receiving, via the capability information, an indication of a quantity of beams in the second set of beams, a type of beams for the second set of beams, or a combination thereof, based on the threshold prediction accuracy.

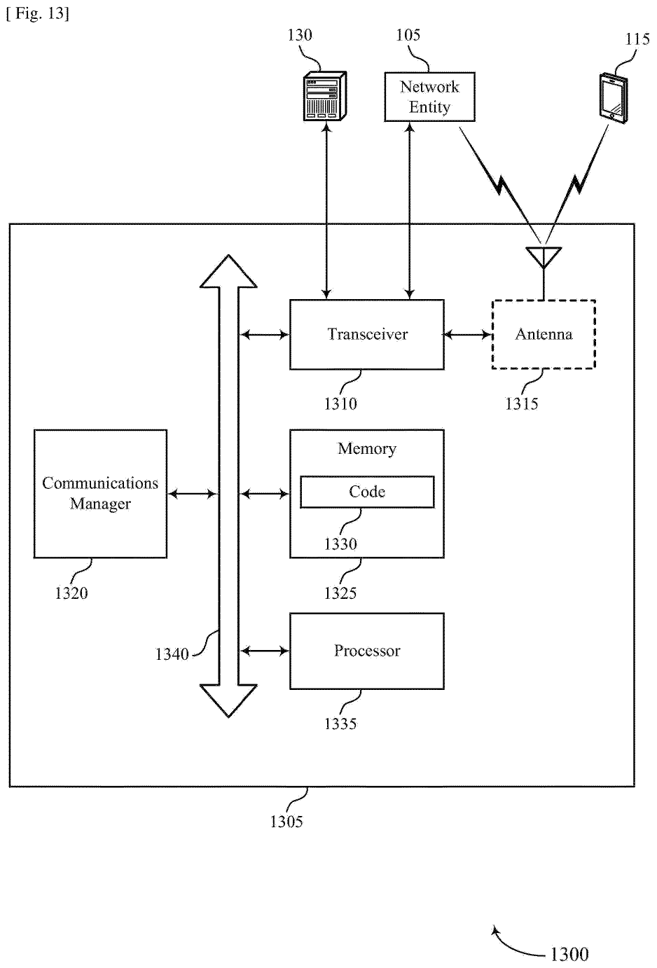

FIG. 13 illustrates a diagram of a system 1300 including a device 1305 that supports cross-serving cell predictive beam management in accordance with one or more aspects of the present disclosure. The device 1305 may be an example of or include the components of a device 1005, a device 1105, or a network entity 105 as described herein. The device 1305 may communicate with one or more network entities 105, one or more UEs 115, or any combination thereof, which may include communications over one or more wired interfaces, over one or more wireless interfaces, or any combination thereof. The device 1305 may include components that support outputting and obtaining communications, such as a communications manager 1320, a transceiver 1310, an antenna 1315, a memory 1325, code 1330, and a processor 1335. These components may be in electronic communication or otherwise coupled (e.g., operatively, communicatively, functionally, electronically, electrically) via one or more buses (e.g., a bus 1340).

The transceiver 1310 may support bi-directional communications via wired links, wireless links, or both as described herein. In some examples, the transceiver 1310 may include a wired transceiver and may communicate bi-directionally with another wired transceiver. Additionally, or alternatively, in some examples, the transceiver 1310 may include a wireless transceiver and may communicate bi-directionally with another wireless transceiver. In some examples, the device 1305 may include one or more antennas 1315, which may be capable of transmitting or receiving wireless transmissions (e.g., concurrently). The transceiver 1310 may also include a modem to modulate signals, to provide the modulated signals for transmission (e.g., by one or more antennas 1315, by a wired transmitter), to receive modulated signals (e.g., from one or more antennas 1315, from a wired receiver), and to demodulate signals. In some implementations, the transceiver 1310 may include one or more interfaces, such as one or more interfaces coupled with the one or more antennas 1315 that are configured to support various receiving or obtaining operations, or one or more interfaces coupled with the one or more antennas 1315 that are configured to support various transmitting or outputting operations, or a combination thereof. In some implementations, the transceiver 1310 may include or be configured for coupling with one or more processors or memory components that are operable to perform or support operations based on received or obtained information or signals, or to generate information or other signals for transmission or other outputting, or any combination thereof. In some implementations, the transceiver 1310, or the transceiver 1310 and the one or more antennas 1315, or the transceiver 1310 and the one or more antennas 1315 and one or more processors or memory components (for example, the processor 1335, or the memory 1325, or both), may be included in a chip or chip assembly that is installed in the device 1305. In some examples, the transceiver may be operable to support communications via one or more communications links (e.g., a communication link 125, a backhaul communication link 120, a midhaul communication link 162, a fronthaul communication link 168).

The memory 1325 may include RAM and ROM. The memory 1325 may store computer-readable, computer-executable code 1330 including instructions that, when executed by the processor 1335, cause the device 1305 to perform various functions described herein. The code 1330 may be stored in a non-transitory computer-readable medium such as system memory or another type of memory. In some cases, the code 1330 may not be directly executable by the processor 1335 but may cause a computer (e.g., when compiled and executed) to perform functions described herein. In some cases, the memory 1325 may contain, among other things, a BIOS which may control basic hardware or software operation such as the interaction with peripheral components or devices.

The processor 1335 may include an intelligent hardware device (e.g., a general-purpose processor, a DSP, a GPU, an ASIC, a CPU, an FPGA, a microcontroller, a programmable logic device, discrete gate or transistor logic, a discrete hardware component, or any combination thereof). In some cases, the processor 1335 may be configured to operate a memory array using a memory controller. In some other cases, a memory controller may be integrated into the processor 1335. The processor 1335 may be configured to execute computer-readable instructions stored in a memory (e.g., the memory 1325) to cause the device 1305 to perform various functions (e.g., functions or tasks supporting cross-serving cell predictive beam management). For example, the device 1305 or a component of the device 1305 may include a processor 1335 and memory 1325 coupled with the processor 1335, the processor 1335 and memory 1325 configured to perform various functions described herein. The processor 1335 may be an example of a cloud-computing platform (e.g., one or more physical nodes and supporting software such as operating systems, virtual machines, or container instances) that may host the functions (e.g., by executing code 1330) to perform the functions of the device 1305. The processor 1335 may be any one or more suitable processors capable of executing scripts or instructions of one or more software programs stored in the device 1305 (such as within the memory 1325). In some implementations, the processor 1335 may be a component of a processing system. A processing system may generally refer to a system or series of machines or components that receives inputs and processes the inputs to produce a set of outputs (which may be passed to other systems or components of, for example, the device 1305). For example, a processing system of the device 1305 may refer to a system including the various other components or subcomponents of the device 1305, such as the processor 1335, or the transceiver 1310, or the communications manager 1320, or other components or combinations of components of the device 1305. The processing system of the device 1305 may interface with other components of the device 1305, and may process information received from other components (such as inputs or signals) or output information to other components. For example, a chip or modem of the device 1305 may include a processing system and one or more interfaces to output information, or to obtain information, or both. The one or more interfaces may be implemented as or otherwise include a first interface configured to output information and a second interface configured to obtain information, or a same interface configured to output information and to obtain information, among other implementations. In some implementations, the one or more interfaces may refer to an interface between the processing system of the chip or modem and a transmitter, such that the device 1305 may transmit information output from the chip or modem. Additionally, or alternatively, in some implementations, the one or more interfaces may refer to an interface between the processing system of the chip or modem and a receiver, such that the device 1305 may obtain information or signal inputs, and the information may be passed to the processing system. A person having ordinary skill in the art will readily recognize that a first interface also may obtain information or signal inputs, and a second interface also may output information or signal outputs.

In some examples, a bus 1340 may support communications of (e.g., within) a protocol layer of a protocol stack. In some examples, a bus 1340 may support communications associated with a logical channel of a protocol stack (e.g., between protocol layers of a protocol stack), which may include communications performed within a component of the device 1305, or between different components of the device 1305 that may be co-located or located in different locations (e.g., where the device 1305 may refer to a system in which one or more of the communications manager 1320, the transceiver 1310, the memory 1325, the code 1330, and the processor 1335 may be located in one of the different components or divided between different components).

In some examples, the communications manager 1320 may manage aspects of communications with a core network 130 (e.g., via one or more wired or wireless backhaul links). For example, the communications manager 1320 may manage the transfer of data communications for client devices, such as one or more UEs 115. In some examples, the communications manager 1320 may manage communications with other network entities 105, and may include a controller or scheduler for controlling communications with UEs 115 in cooperation with other network entities 105. In some examples, the communications manager 1320 may support an X2 interface within an LTE/LTE-A wireless communications network technology to provide communication between network entities 105.

The communications manager 1320 may support wireless communications at a network entity in accordance with examples as disclosed herein. For example, the communications manager 1320 may be configured as or otherwise support a means for transmitting, via a first serving cell to a UE, control signaling indicating a cross serving cell scheme that identifies a first set of resources of a second serving cell that are associated with a second set of resources of the second serving cell, the first set of resources for measuring channel quality for a first set of beams and the second set of resources for predicting channel quality for a second set of beams. The communications manager 1320 may be configured as or otherwise support a means for receiving, from the UE via the first serving cell, based on the cross serving cell scheme, a CSI report indicating predicted channel quality information for the second set of resources for the second set of beams associated with the second serving cell.

By including or configuring the communications manager 1320 in accordance with examples as described herein, the device 1305 may support techniques for reduced latency by reducing a duration of time that the UE performs channel quality measurements based on switching from a first serving cell to a second serving cell. For example, the UE may perform fewer channel quality measurements in the second serving cell by utilizing channel quality measurements previously performed in other serving cells, which may reduce latency for users of the UE, for example, in cases where the UE is mobile.

In some examples, the communications manager 1320 may be configured to perform various operations (e.g., receiving, obtaining, monitoring, outputting, transmitting) using or otherwise in cooperation with the transceiver 1310, the one or more antennas 1315 (e.g., where applicable), or any combination thereof. Although the communications manager 1320 is illustrated as a separate component, in some examples, one or more functions described with reference to the communications manager 1320 may be supported by or performed by the transceiver 1310, the processor 1335, the memory 1325, the code 1330, or any combination thereof. For example, the code 1330 may include instructions executable by the processor 1335 to cause the device 1305 to perform various aspects of cross-serving cell predictive beam management as described herein, or the processor 1335 and the memory 1325 may be otherwise configured to perform or support such operations.

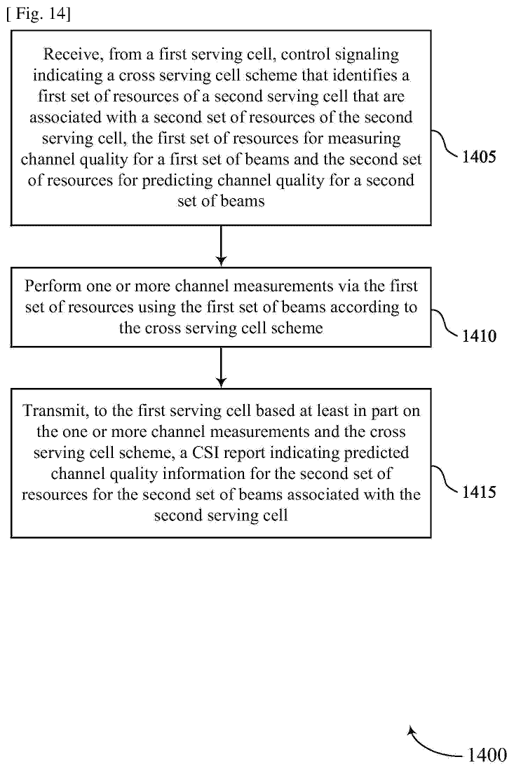

FIG. 14 illustrates a flowchart showing a method 1400 that supports cross-serving cell predictive beam management in accordance with one or more aspects of the present disclosure. The operations of the method 1400 may be implemented by a UE or its components as described herein. For example, the operations of the method 1400 may be performed by a UE 115 as described with reference to FIGS. 1 through 9. In some examples, a UE may execute a set of instructions to control the functional elements of the UE to perform the described functions. Additionally, or alternatively, the UE may perform aspects of the described functions using special-purpose hardware.

At 1405, the method may include receiving, from a first serving cell, control signaling indicating a cross serving cell scheme that identifies a first set of resources of a second serving cell that are associated with a second set of resources of the second serving cell, the first set of resources for measuring channel quality for a first set of beams and the second set of resources for predicting channel quality for a second set of beams. The operations of 1405 may be performed in accordance with examples as disclosed herein. In some examples, aspects of the operations of 1405 may be performed by a cross serving cell scheme component 825 as described with reference to FIG. 8.

At 1410, the method may include performing one or more channel measurements via the first set of resources using the first set of beams according to the cross serving cell scheme. The operations of 1410 may be performed in accordance with examples as disclosed herein. In some examples, aspects of the operations of 1410 may be performed by a channel measurement component 830 as described with reference to FIG. 8.

At 1415, the method may include transmitting, to the first serving cell based at least in part on the one or more channel measurements and the cross serving cell scheme, a CSI report indicating predicted channel quality information for the second set of resources for the second set of beams associated with the second serving cell. The operations of 1415 may be performed in accordance with examples as disclosed herein. In some examples, aspects of the operations of 1415 may be performed by a CSI component 835 as described with reference to FIG. 8.

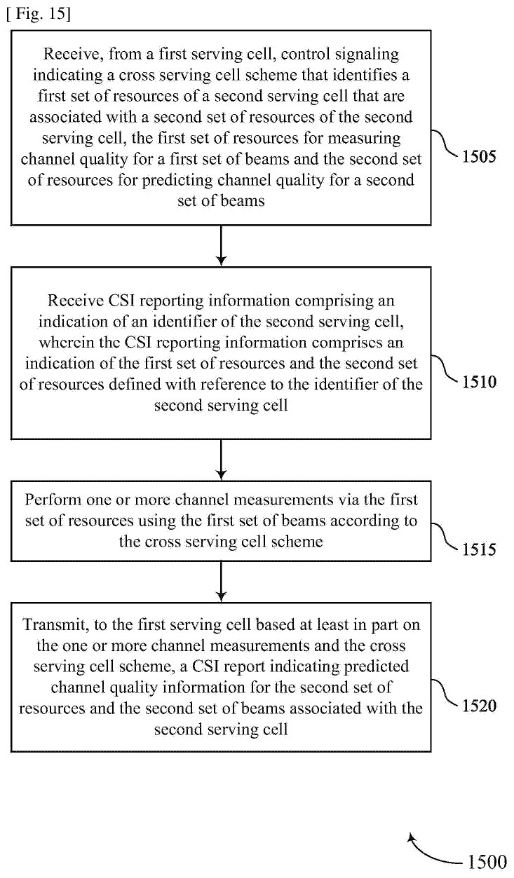

FIG. 15 illustrates a flowchart showing a method 1500 that supports cross-serving cell predictive beam management in accordance with one or more aspects of the present disclosure. The operations of the method 1500 may be implemented by a UE or its components as described herein. For example, the operations of the method 1500 may be performed by a UE 115 as described with reference to FIGS. 1 through 9. In some examples, a UE may execute a set of instructions to control the functional elements of the UE to perform the described functions. Additionally, or alternatively, the UE may perform aspects of the described functions using special-purpose hardware.

At 1505, the method may include receiving, from a first serving cell, control signaling indicating a cross serving cell scheme that identifies a first set of resources of a second serving cell that are associated with a second set of resources of the second serving cell, the first set of resources for measuring channel quality for a first set of beams and the second set of resources for predicting channel quality for a second set of beams. The operations of 1505 may be performed in accordance with examples as disclosed herein. In some examples, aspects of the operations of 1505 may be performed by a cross serving cell scheme component 825 as described with reference to FIG. 8.

At 1510, the method may include receiving CSI reporting information comprising an indication of an identifier of the second serving cell, wherein the CSI reporting information includes an indication of the first set of resources and the second set of resources defined with reference to the identifier of the second serving cell. The operations of 1510 may be performed in accordance with examples as disclosed herein. In some examples, aspects of the operations of 1510 may be performed by a cross serving cell scheme component 825 as described with reference to FIG. 8.

At 1515, the method may include performing one or more channel measurements via the first set of resources using the first set of beams according to the cross serving cell scheme. The operations of 1515 may be performed in accordance with examples as disclosed herein. In some examples, aspects of the operations of 1515 may be performed by a channel measurement component 830 as described with reference to FIG. 8.

At 1520, the method may include transmitting, to the first serving cell based at least in part on the one or more channel measurements and the cross serving cell scheme, a CSI report indicating predicted channel quality information for the second set of resources for the second set of beams associated with the second serving cell. The operations of 1520 may be performed in accordance with examples as disclosed herein. In some examples, aspects of the operations of 1520 may be performed by a CSI component 835 as described with reference to FIG. 8.

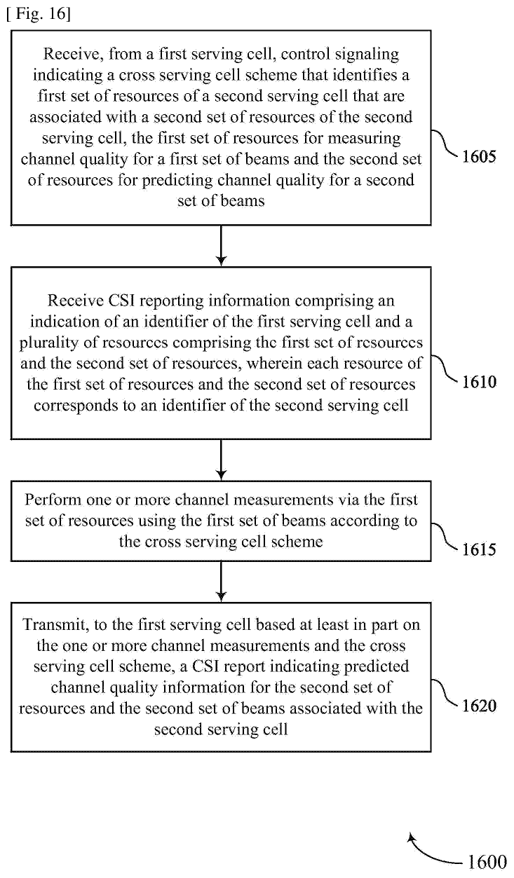

FIG. 16 illustrates a flowchart showing a method 1600 that supports cross-serving cell predictive beam management in accordance with one or more aspects of the present disclosure. The operations of the method 1600 may be implemented by a UE or its components as described herein. For example, the operations of the method 1600 may be performed by a UE 115 as described with reference to FIGS. 1 through 9. In some examples, a UE may execute a set of instructions to control the functional elements of the UE to perform the described functions. Additionally, or alternatively, the UE may perform aspects of the described functions using special-purpose hardware.

At 1605, the method may include receiving, from a first serving cell, control signaling indicating a cross serving cell scheme that identifies a first set of resources of a second serving cell that are associated with a second set of resources of the second serving cell, the first set of resources for measuring channel quality for a first set of beams and the second set of resources for predicting channel quality for a second set of beams. The operations of 1605 may be performed in accordance with examples as disclosed herein. In some examples, aspects of the operations of 1605 may be performed by a cross serving cell scheme component 825 as described with reference to FIG. 8.

At 1610, the method may include receiving CSI reporting information comprising an indication of an identifier of the first serving cell and a plurality of resources comprising the first set of resources and the second set of resources, wherein each resource of the first set of resources and the second set of resources corresponds to an identifier of the second serving cell. The operations of 1610 may be performed in accordance with examples as disclosed herein. In some examples, aspects of the operations of 1610 may be performed by a cross serving cell scheme component 825 as described with reference to FIG. 8.

At 1615, the method may include performing one or more channel measurements via the first set of resources using the first set of beams according to the cross serving cell scheme. The operations of 1615 may be performed in accordance with examples as disclosed herein. In some examples, aspects of the operations of 1615 may be performed by a channel measurement component 830 as described with reference to FIG. 8.

At 1620, the method may include transmitting, to the first serving cell based at least in part on the one or more channel measurements and the cross serving cell scheme, a CSI report indicating predicted channel quality information for the second set of resources for the second set of beams associated with the second serving cell. The operations of 1620 may be performed in accordance with examples as disclosed herein. In some examples, aspects of the operations of 1620 may be performed by a CSI component 835 as described with reference to FIG. 8.

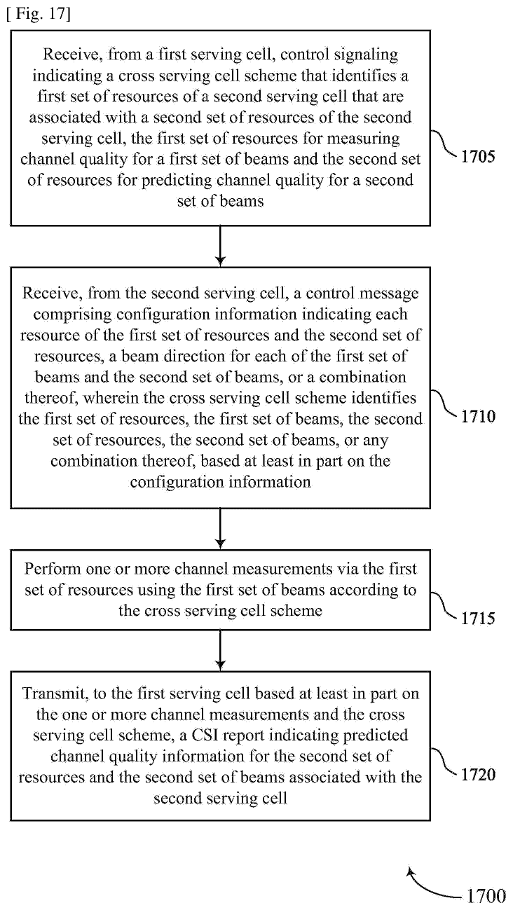

FIG. 17 illustrates a flowchart showing a method 1700 that supports cross-serving cell predictive beam management in accordance with one or more aspects of the present disclosure. The operations of the method 1700 may be implemented by a UE or its components as described herein. For example, the operations of the method 1700 may be performed by a UE 115 as described with reference to FIGS. 1 through 9. In some examples, a UE may execute a set of instructions to control the functional elements of the UE to perform the described functions. Additionally, or alternatively, the UE may perform aspects of the described functions using special-purpose hardware.

At 1705, the method may include receiving, from a first serving cell, control signaling indicating a cross serving cell scheme that identifies a first set of resources of a second serving cell that are associated with a second set of resources of the second serving cell, the first set of resources for measuring channel quality for a first set of beams and the second set of resources for predicting channel quality for a second set of beams. The operations of 1705 may be performed in accordance with examples as disclosed herein. In some examples, aspects of the operations of 1705 may be performed by a cross serving cell scheme component 825 as described with reference to FIG. 8.

At 1710, the method may include receiving, from the second serving cell, a control message comprising configuration information indicating each resource of the first set of resources and the second set of resources, a beam direction for each of the first set of beams and the second set of beams, or a combination thereof, wherein the cross serving cell scheme identifies the first set of resources, the first set of beams, the second set of resources, the second set of beams, or any combination thereof, based at least in part on the configuration information. The operations of 1710 may be performed in accordance with examples as disclosed herein. In some examples, aspects of the operations of 1710 may be performed by a configuration component 840 as described with reference to FIG. 8.

At 1715, the method may include performing one or more channel measurements via the first set of resources using the first set of beams according to the cross serving cell scheme. The operations of 1715 may be performed in accordance with examples as disclosed herein. In some examples, aspects of the operations of 1715 may be performed by a channel measurement component 830 as described with reference to FIG. 8.

At 1720, the method may include transmitting, to the first serving cell based at least in part on the one or more channel measurements and the cross serving cell scheme, a CSI report indicating predicted channel quality information for the second set of resources for the second set of beams associated with the second serving cell. The operations of 1720 may be performed in accordance with examples as disclosed herein. In some examples, aspects of the operations of 1720 may be performed by a CSI component 835 as described with reference to FIG. 8.

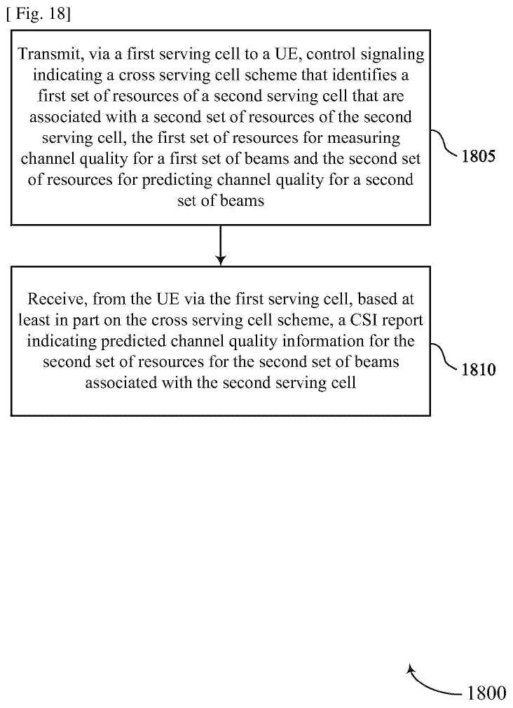

FIG. 18 illustrates a flowchart showing a method 1800 that supports cross-serving cell predictive beam management in accordance with one or more aspects of the present disclosure. The operations of the method 1800 may be implemented by a network entity or its components as described herein. For example, the operations of the method 1800 may be performed by a network entity as described with reference to FIGS. 1 through 5 and 10 through 13. In some examples, a network entity may execute a set of instructions to control the functional elements of the network entity to perform the described functions. Additionally, or alternatively, the network entity may perform aspects of the described functions using special-purpose hardware.

At 1805, the method may include transmitting, via a first serving cell to a UE, control signaling indicating a cross serving cell scheme that identifies a first set of resources of a second serving cell that are associated with a second set of resources of the second serving cell, the first set of resources for measuring channel quality for a first set of beams and the second set of resources for predicting channel quality for a second set of beams. The operations of 1805 may be performed in accordance with examples as disclosed herein. In some examples, aspects of the operations of 1805 may be performed by a cross serving cell scheme manager 1225 as described with reference to FIG. 12.

At 1810, the method may include receiving, from the UE via the first serving cell, based at least in part on the cross serving cell scheme, a CSI report indicating predicted channel quality information for the second set of resources for the second set of beams associated with the second serving cell. The operations of 1810 may be performed in accordance with examples as disclosed herein. In some examples, aspects of the operations of 1810 may be performed by a channel measurement manager 1230 as described with reference to FIG. 12.

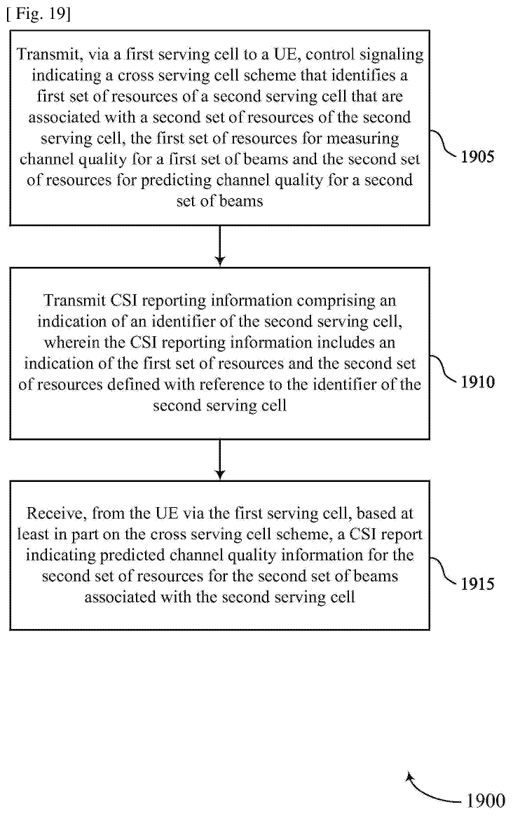

FIG. 19 illustrates a flowchart showing a method 1900 that supports cross-serving cell predictive beam management in accordance with one or more aspects of the present disclosure. The operations of the method 1900 may be implemented by a network entity or its components as described herein. For example, the operations of the method 1900 may be performed by a network entity as described with reference to FIGS. 1 through 5 and 10 through 13. In some examples, a network entity may execute a set of instructions to control the functional elements of the network entity to perform the described functions. Additionally, or alternatively, the network entity may perform aspects of the described functions using special-purpose hardware.

At 1905, the method may include transmitting, via a first serving cell to a UE, control signaling indicating a cross serving cell scheme that identifies a first set of resources of a second serving cell that are associated with a second set of resources of the second serving cell, the first set of resources for measuring channel quality for a first set of beams and the second set of resources for predicting channel quality for a second set of beams. The operations of 1905 may be performed in accordance with examples as disclosed herein. In some examples, aspects of the operations of 1905 may be performed by a cross serving cell scheme manager 1225 as described with reference to FIG. 12.

At 1910, the method may include transmitting CSI reporting information comprising an indication of an identifier of the second serving cell, wherein the CSI reporting information includes an indication of the first set of resources and the second set of resources defined with reference to the identifier of the second serving cell. The operations of 1910 may be performed in accordance with examples as disclosed herein. In some examples, aspects of the operations of 1910 may be performed by a cross serving cell scheme manager 1225 as described with reference to FIG. 12.

At 1915, the method may include receiving, from the UE via the first serving cell, based at least in part on the cross serving cell scheme, a CSI report indicating predicted channel quality information for the second set of resources for the second set of beams associated with the second serving cell. The operations of 1915 may be performed in accordance with examples as disclosed herein. In some examples, aspects of the operations of 1915 may be performed by a channel measurement manager 1230 as described with reference to FIG. 12.

The following provides an overview of aspects of the present disclosure:

Aspect 1: A method for wireless communications at a UE, comprising: receiving, from a first serving cell, control signaling indicating a cross serving cell scheme that identifies a first set of resources of a second serving cell that are associated with a second set of resources of the second serving cell, the first set of resources for measuring channel quality for a first set of beams and the second set of resources for predicting channel quality for a second set of beams; performing one or more channel measurements via the first set of resources using the first set of beams according to the cross serving cell scheme; and transmitting, to the first serving cell based at least in part on the one or more channel measurements and the cross serving cell scheme, a CSI report indicating predicted channel quality information for the second set of resources for the second set of beams associated with the second serving cell.

Aspect 2: The method of aspect 1, wherein receiving the control signaling comprises: receiving CSI reporting information comprising an indication of an identifier of the second serving cell, wherein the CSI reporting information comprises an indication of the first set of resources and the second set of resources defined with reference to the identifier of the second serving cell.

Aspect 3: The method of aspect 2, wherein receiving the CSI reporting information comprises: receiving a CSI report setting message, a MAC-CE activating the CSI report, a CSI configuration message triggering the CSI report, or any combination thereof.

Aspect 4: The method of any of aspects 1 through 3, wherein receiving the control signaling comprises: receiving CSI reporting information comprising an indication of an identifier of the first serving cell and a plurality of resources comprising the first set of resources and the second set of resources, wherein each resource of the first set of resources and the second set of resources corresponds to an identifier of the second serving cell.

Aspect 5: The method of any of aspects 1 through 4, further comprising: receiving, from the second serving cell, a control message comprising configuration information indicating each resource of the first set of resources and the second set of resources, a beam direction for each of the first set of beams and the second set of beams, or a combination thereof, wherein the cross serving cell scheme identifies the first set of resources, the first set of beams, the second set of resources, the second set of beams, or any combination thereof, based at least in part on the configuration information.

Aspect 6: The method of aspect 5, further comprising: receiving, via the configuration information, an indication of a codebook comprising a set of candidate resources, a set of candidate beam directions, a set of candidate beam widths, or any combination thereof, wherein the cross serving cell scheme comprises a codepoint of the codebook indicating the first set of resources, the first set of beams, the second set of resources, the second set of beams, or any combination thereof.

Aspect 7: The method of any of aspects 1 through 6, further comprising: transmitting capability information indicating that the UE supports beam prediction based on the cross serving cell scheme, wherein receiving the control signaling indicating the cross serving cell scheme is based at least in part on the capability information.

Aspect 8: The method of aspect 7, further comprising: transmitting, via the capability information, an indication that the UE supports beam prediction for the second serving cell via the first serving cell.

Aspect 9: The method of any of aspects 7 through 8, further comprising: transmitting, via the capability information, a quantity of serving cells for which the UE supports the cross serving cell scheme, the quantity of serving cells comprising the second serving cell.

Aspect 10: The method of any of aspects 7 through 9, further comprising: transmitting, via the capability information, an indication of a threshold prediction accuracy for the second serving cell.

Aspect 11: The method of aspect 10, wherein the threshold prediction accuracy is based at least in part on a location of the UE.

Aspect 12: The method of any of aspects 10 through 11, further comprising: transmitting, via the capability information, an indication of a quantity of beams in the second set of beams, a type of beams for the second set of beams, or a combination thereof, based at least in part on the threshold prediction accuracy.

Aspect 13: A method for wireless communications at a network entity, comprising: transmitting, via a first serving cell to a UE, control signaling indicating a cross serving cell scheme that identifies a first set of resources of a second serving cell that are associated with a second set of resources of the second serving cell, the first set of resources for measuring channel quality for a first set of beams and the second set of resources for predicting channel quality for a second set of beams; and receiving, from the UE via the first serving cell, based at least in part on the cross serving cell scheme, a CSI report indicating predicted channel quality information for the second set of resources for the second set of beams associated with the second serving cell.

Aspect 14: The method of aspect 13, wherein transmitting the control signaling comprises: transmitting CSI reporting information comprising an indication of an identifier of the second serving cell, wherein the CSI reporting information comprises an indication of the first set of resources and the second set of resources defined with reference to the identifier of the second serving cell.

Aspect 15: The method of aspect 14, wherein transmitting the control signaling comprises: transmitting a CSI report setting message, a MAC-CE activating the CSI report, a CSI configuration message triggering the CSI report, or any combination thereof.

Aspect 16: The method of any of aspects 13 through 15, wherein transmitting the control signaling comprises: CSI reporting information comprising an indication of an identifier of the first serving cell and a plurality of resources comprising the first set of resources and the second set of resources, wherein each resource of the first set of resources and the second set of resources corresponds to an identifier of the second serving cell.

Aspect 17: The method of any of aspects 13 through 16, wherein the cross serving cell scheme identifies the first set of resources, the first set of beams, the second set of resources, the second set of beams, or any combination thereof, based at least in part on configuration information from the second serving cell indicating each resource of the first set of resources and the second set of resources, a beam direction for each of the first set of beams and the second set of beams, or a combination thereof.

Aspect 18: The method of aspect 17, wherein an indication of a codebook comprising a set of candidate resources, a set of candidate beam directions, a set of candidate beam widths, or any combination thereof; and the cross serving cell scheme comprises a codepoint of the codebook indicating the first set of resources, the first set of beams, the second set of resources, the second set of beams, or any combination thereof.

Aspect 19: The method of any of aspects 13 through 18, further comprising: receiving capability information indicating that the UE supports beam prediction based on the cross serving cell scheme, wherein transmitting the control signaling indicating the cross serving cell scheme is based at least in part on the capability information.

Aspect 20: The method of aspect 19, further comprising: receiving, via the capability information, a quantity of serving cells for which the UE supports the cross serving cell scheme, the quantity of serving cells comprising the second serving cell.

Aspect 21: The method of any of aspects 19 through 20, further comprising: receiving, via the capability information, an indication of a threshold prediction accuracy for the second serving cell.

Aspect 22: The method of aspect 21, wherein the threshold prediction accuracy is based at least in part on a location of the UE.

Aspect 23: The method of any of aspects 21 through 22, further comprising: receiving, via the capability information, an indication of a quantity of beams in the second set of beams, a type of beams for the second set of beams, or a combination thereof, based at least in part on the threshold prediction accuracy.

Aspect 24: An apparatus for wireless communications at a UE, comprising at least one processor; and memory coupled with the at least one processor, the memory storing instructions executable by the at least one processor to cause the UE to perform a method of any of aspects 1 through 12.

Aspect 25: An apparatus for wireless communications at a UE, comprising at least one means for performing a method of any of aspects 1 through 12.

Aspect 26: A non-transitory computer-readable medium storing code for wireless communications at a UE, the code comprising instructions executable by at least one processor to perform a method of any of aspects 1 through 12.

Aspect 27: An apparatus for wireless communications at a network entity, comprising at least one processor; and memory coupled with the at least one processor, the memory storing instructions executable by the at least one processor to cause the network entity to perform a method of any of aspects 13 through 23.

Aspect 28: An apparatus for wireless communications at a network entity, comprising at least one means for performing a method of any of aspects 13 through 23.

Aspect 29: A non-transitory computer-readable medium storing code for wireless communications at a network entity, the code comprising instructions executable by at least one processor to perform a method of any of aspects 13 through 23.

It should be noted that the methods described herein describe possible implementations, and that the operations and the steps may be rearranged or otherwise modified and that other implementations are possible. Further, aspects from two or more of the methods may be combined.

Although aspects of an LTE, LTE-A, LTE-A Pro, or NR system may be described for purposes of example, and LTE, LTE-A, LTE-A Pro, or NR terminology may be used in much of the description, the techniques described herein are applicable beyond LTE, LTE-A, LTE-A Pro, or NR networks. For example, the described techniques may be applicable to various other wireless communications systems such as Ultra Mobile Broadband (UMB), Institute of Electrical and Electronics Engineers (IEEE) 802.11 (Wi-Fi), IEEE 802.16 (WiMAX), IEEE 802.20, Flash-OFDM, as well as other systems and radio technologies, including future systems and radio technologies, not explicitly mentioned herein.

Information and signals described herein may be represented using any of a variety of different technologies and techniques. For example, data, instructions, commands, information, signals, bits, symbols, and chips that may be referenced throughout the description may be represented by voltages, currents, electromagnetic waves, magnetic fields or particles, optical fields or particles, or any combination thereof.

The various illustrative blocks and components described in connection with the disclosure herein may be implemented or performed using a general-purpose processor, a DSP, a GPU, an ASIC, a CPU, an FPGA or other programmable logic device, discrete gate or transistor logic, discrete hardware components, or any combination thereof designed to perform the functions described herein. A general-purpose processor may be a microprocessor but, in the alternative, the processor may be any processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration).

The functions described herein may be implemented using hardware, software executed by a processor, or any combination thereof. Software shall be construed broadly to mean instructions, instruction sets, code, code segments, program code, programs, subprograms, software modules, applications, software applications, software packages, routines, subroutines, objects, executables, threads of execution, procedures, or functions, whether referred to as software, firmware, middleware, microcode, hardware description language, or otherwise. If implemented using software executed by a processor, the functions may be stored as or transmitted using one or more instructions or code of a computer-readable medium. Other examples and implementations are within the scope of the disclosure and appended claims. For example, due to the nature of software, functions described herein may be implemented using software executed by a processor, hardware, hardwiring, or combinations of any of these. Features implementing functions may also be physically located at various positions, including being distributed such that portions of functions are implemented at different physical locations.

Computer-readable media includes both non-transitory computer storage media and communication media including any medium that facilitates transfer of a computer program from one location to another. A non-transitory storage medium may be any available medium that may be accessed by a general-purpose or special-purpose computer. By way of example, and not limitation, non-transitory computer-readable media may include RAM, ROM, electrically erasable programmable ROM (EEPROM), flash memory, phase change memory, compact disk (CD) ROM or other optical disk storage, magnetic disk storage or other magnetic storage devices, or any other non-transitory medium that may be used to carry or store desired program code means in the form of instructions or data structures and that may be accessed by a general-purpose or special-purpose computer, or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of computer-readable medium. Disk and disc, as used herein, include CD, laser disc, optical disc, digital versatile disc (DVD), floppy disk and Blu-ray disc. Disks may reproduce data magnetically, and discs may reproduce data optically using lasers. Combinations of the above are also included within the scope of computer-readable media.

As used herein, including in the claims, “or” as used in a list of items (e.g., including a list of items prefaced by a phrase such as “at least one of” or “one or more of”) indicates an inclusive list such that, for example, a list of at least one of A, B, or C means, e.g., A or B or C or AB or AC or BC or ABC (i.e., A and B and C). Also, as used herein, the phrase “based on” shall not be construed as a reference to a closed set of conditions. For example, an example step that is described as “based on condition A” may be based on both a condition A and a condition B without departing from the scope of the present disclosure. In other words, as used herein, the phrase “based on” shall be construed in the same manner as the phrase “based at least in part on.” As used herein, the term “and/or,” when used in a list of two or more items, means that any one of the listed items can be employed by itself, or any combination of two or more of the listed items can be employed. For example, if a composition is described as containing components A, B, and/or C, the composition can contain A alone; B alone; C alone; A and B in combination; A and C in combination; B and C in combination; or A, B, and C in combination.

The term “determine” or “determining” or “identify” or “identifying” encompasses a variety of actions and, therefore, “determining” or “identifying” can include calculating, computing, processing, deriving, investigating, looking up (such as via looking up in a table, a database or another data structure), ascertaining and the like. Also, “determining” or “identifying” can include receiving (such as receiving information or signaling, e.g., receiving information or signaling for determining, receiving information or signaling for identifying), accessing (such as accessing data in a memory, or accessing information) and the like. Also, “determining” or “identifying” can include resolving, obtaining, selecting, choosing, establishing and other such similar actions. In the appended figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label, or other subsequent reference label.

The description set forth herein, in connection with the appended drawings, describes example configurations and does not represent all the examples that may be implemented or that are within the scope of the claims. The term “example” used herein means “serving as an example, instance, or illustration,” and not “preferred” or “advantageous over other examples.” The detailed description includes specific details for the purpose of providing an understanding of the described techniques. These techniques, however, may be practiced without these specific details. In some instances, known structures and devices are shown in block diagram form in order to avoid obscuring the concepts of the described examples.

The description herein is provided to enable a person having ordinary skill in the art to make or use the disclosure. Various modifications to the disclosure will be apparent to a person having ordinary skill in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

1. An apparatus for wireless communications at a user equipment (UE), comprising:
at least one processor; and
memory coupled with the at least one processor, the memory storing instructions executable by the at least one processor to cause the UE to:
receive, from a first serving cell, control signaling indicating a cross serving cell scheme that identifies a first set of resources of a second serving cell that are associated with a second set of resources of the second serving cell, the first set of resources for measuring channel quality for a first set of beams and the second set of resources for predicting channel quality for a second set of beams;
perform one or more channel measurements via the first set of resources using the first set of beams according to the cross serving cell scheme; and
transmit, to the first serving cell based at least in part on the one or more channel measurements and the cross serving cell scheme, a channel state information report indicating predicted channel quality information for the second set of resources for the second set of beams associated with the second serving cell.

2. The apparatus of claim 1, wherein the instructions to receive the control signaling are executable by the at least one processor to cause the apparatus to:
receive channel state information reporting information comprising an indication of an identifier of the second serving cell, wherein the channel state information reporting information comprises an indication of the first set of resources and the second set of resources defined with reference to the identifier of the second serving cell.

3. The apparatus of claim 2, wherein the instructions to receive the channel state information reporting information are executable by the at least one processor to cause the apparatus to:
receive a channel state information report setting message, a medium access control (MAC) control element (CE) activating the channel state information report, a channel state information configuration message triggering the channel state information report, or any combination thereof.

4. The apparatus of claim 1, wherein the instructions to receive the control signaling are executable by the at least one processor to cause the apparatus to:
receive channel state information reporting information comprising an indication of an identifier of the first serving cell and a plurality of resources comprising the first set of resources and the second set of resources, wherein each resource of the first set of resources and the second set of resources corresponds to an identifier of the second serving cell.

5. The apparatus of claim 1, wherein the instructions are further executable by the at least one processor to cause the apparatus to:
receive, from the second serving cell, a control message comprising configuration information indicating each resource of the first set of resources and the second set of resources, a beam direction for each of the first set of beams and the second set of beams, or a combination thereof, wherein the cross serving cell scheme identifies the first set of resources, the first set of beams, the second set of resources, the second set of beams, or any combination thereof, based at least in part on the configuration information.

6. The apparatus of claim 5, wherein the instructions are further executable by the at least one processor to cause the apparatus to:
receive, via the configuration information, an indication of a codebook comprising a set of candidate resources, a set of candidate beam directions, a set of candidate beam widths, or any combination thereof, wherein the cross serving cell scheme comprises a codepoint of the codebook indicating the first set of resources, the first set of beams, the second set of resources, the second set of beams, or any combination thereof.

7. The apparatus of claim 1, wherein the instructions are further executable by the at least one processor to cause the apparatus to:
transmit capability information indicating that the UE supports beam prediction based on the cross serving cell scheme, wherein receiving the control signaling indicating the cross serving cell scheme is based at least in part on the capability information.

8. The apparatus of claim 7, wherein the instructions are further executable by the at least one processor to cause the apparatus to:
transmit, via the capability information, an indication that the UE supports beam prediction for the second serving cell via the first serving cell.

9. The apparatus of claim 7, wherein the instructions are further executable by the at least one processor to cause the apparatus to:
transmit, via the capability information, a quantity of serving cells for which the UE supports the cross serving cell scheme, the quantity of serving cells comprising the second serving cell.

10. The apparatus of claim 7, wherein the instructions are further executable by the at least one processor to cause the apparatus to:
transmit, via the capability information, an indication of a threshold prediction accuracy for the second serving cell.

11. The apparatus of claim 10, wherein the threshold prediction accuracy is based at least in part on a location of the UE.

12. The apparatus of claim 10, wherein the instructions are further executable by the at least one processor to cause the apparatus to:
transmit, via the capability information, an indication of a quantity of beams in the second set of beams, a type of beams for the second set of beams, or a combination thereof, based at least in part on the threshold prediction accuracy.

13. An apparatus for wireless communications at a network entity, comprising:
at least one processor; and
memory coupled with the at least one processor, the memory storing instructions executable by the at least one processor to cause the network entity to:
transmit, via a first serving cell to a user equipment (UE), control signaling indicating a cross serving cell scheme that identifies a first set of resources of a second serving cell that are associated with a second set of resources of the second serving cell, the first set of resources for measuring channel quality for a first set of beams and the second set of resources for predicting channel quality for a second set of beams; and
receive, from the UE via the first serving cell, based at least in part on the cross serving cell scheme, a channel state information report indicating predicted channel quality information for the second set of resources for the second set of beams associated with the second serving cell.

14. The apparatus of claim 13, wherein the instructions to transmit the control signaling are executable by the at least one processor to cause the apparatus to:
transmit channel state information reporting information comprising an indication of an identifier of the second serving cell, wherein the channel state information reporting information comprises an indication of the first set of resources and the second set of resources defined with reference to the identifier of the second serving cell.

15. The apparatus of claim 14, wherein the instructions to transmit the control signaling are executable by the at least one processor to cause the apparatus to:
transmit a channel state information report setting message, a medium access control (MAC) control element (CE) activating the channel state information report, a channel state information configuration message triggering the channel state information report, or any combination thereof.

16. The apparatus of claim 13, wherein the instructions to transmit the control signaling are executable by the at least one processor to cause the apparatus to:
channel state information reporting information comprising an indication of an identifier of the first serving cell and a plurality of resources comprising the first set of resources and the second set of resources, wherein each resource of the first set of resources and the second set of resources corresponds to an identifier of the second serving cell.

17. The apparatus of claim 13, wherein the cross serving cell scheme identifies the first set of resources, the first set of beams, the second set of resources, the second set of beams, or any combination thereof, based at least in part on configuration information from the second serving cell indicating each resource of the first set of resources and the second set of resources, a beam direction for each of the first set of beams and the second set of beams, or a combination thereof.

18. The apparatus of claim 17, wherein:
the configuration information comprises an indication of a codebook comprising a set of candidate resources, a set of candidate beam directions, a set of candidate beam widths, or any combination thereof; and
the cross serving cell scheme comprises a codepoint of the codebook indicating the first set of resources, the first set of beams, the second set of resources, the second set of beams, or any combination thereof.

19. The apparatus of claim 13, wherein the instructions are further executable by the at least one processor to cause the apparatus to:
receive capability information indicating that the UE supports beam prediction based on the cross serving cell scheme, wherein transmitting the control signaling indicating the cross serving cell scheme is based at least in part on the capability information.

20. The apparatus of claim 19, wherein the instructions are further executable by the at least one processor to cause the apparatus to:
receive, via the capability information, a quantity of serving cells for which the UE supports the cross serving cell scheme, the quantity of serving cells comprising the second serving cell.

21-30. (canceled)
